(19) United States
(12) Patent Application Publication
(10) Pub. No.: US 2024/0127363 A1
(43) Pub. Date: Apr. 18, 2024

(54) FRAMEWORK FOR CYBER RISK LOSS DISTRIBUTION OF HOSPITAL INFRASTRUCTURE: BOND PERCOLATION OF MIXED RANDOM GRAPHS APPROACH

(71) Applicants: Stefano Chiaradonna, Tempe, AZ (US); Petar Jevtic, Chandler, AZ (US); Nicolas Lanchier, Gilbert, AZ (US)

(72) Inventors: Stefano Chiaradonna, Tempe, AZ (US); Petar Jevtic, Chandler, AZ (US); Nicolas Lanchier, Gilbert, AZ (US)

(73) Assignee: Arizona Board of Regents on behalf of Arizona State University, Tempe, AZ (US)

(21) Appl. No.: 18/132,918

(22) Filed: Apr. 10, 2023

Related U.S. Application Data
(60) Provisional application No. 63/329,298, filed on Apr. 8, 2022.

(51) Int. Cl. G06Q 40/12; G06Q 50/26

(52) U.S. Cl. CPC G06Q 40/12; G06Q 50/26

(57) ABSTRACT

A computing system includes a processor having access to data associated with a plurality of devices of a network. The processor is configured to leverage the data to execute a loss model that estimates cyber risk loss distribution of the network associated with healthcare environment and infrastructure using bond percolation on a mixed random graphs approach.

### CROSS REFERENCE TO RELATED APPLICATIONS

This is a non-provisional application that claims benefit to U.S. Provisional Application Ser. No. 63/329,298, filed on Apr. 8, 2022, which is herein incorporated by reference in its entirety.

### GOVERNMENT SUPPORT

This invention was made with government support under 2000792 awarded by the National Science Foundation. The government has certain rights in the invention.

### FIELD

The present disclosure generally relates to cyber-security and cyber-risk computing systems; and in particular to a system and methods for cyber risk loss distribution of hospital infrastructure via a bond percolation on mixed random graphs approach, among other features described herein.

### BACKGROUND

Networks like those of healthcare infrastructure have been a primary target of cyberattacks for over a decade. From just a single cyberattack, a health-care facility would expect to see millions of dollars in losses from legal fines, business interruption, and loss of revenue. As more medical devices become interconnected, more cyber vulnerabilities emerge, resulting in more potential exploitation that may disrupt patient care and give rise to catastrophic financial losses.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is simplified block diagram of an example computer-implemented system for implementing the framework and/or model described herein for cyber risk loss distribution.

FIG. 1B is a conceptual IT schematic of a prototypical hospital's internal network for major medical assets including devices as described herein.

FIG. 1C is an example process flow associated with the system of FIG. 1A.

FIG. 2 is an illustration of network topology of the hospital described in FIG. 1 with corresponding color scheme for medical devices as described herein.

FIGS. 3A-3B are graphs illustrating the expectation and deviation of loss as s function of pi=p for various values of qi=q for all seven medical components. The network topology and cost distribution are from Table 1 and Table 2, respectively, with assumptions t=1 and λ=1.

FIGS. 4A-4B are graphs illustrating the expectation and deviation of loss as a function of pi=qi for a cyberattack starting from component i. During an attack, the cybersecurity profile of the hospital is high for the connections of all the other medical components with pj=qj=0.3 for all components j does not equal i. The HIS serves as the baseline by having all the connections being the same and unchanged, namely p=q=0.3. The network topology and cost distribution are from Table 1 and Table 2, respectively, with assumptions t=1 and λ=1.

FIGS. 5A-5B are graphs illustrating the expected deviation of loss from various values of the number of patient rooms utilized per CNS for values of p=q with the network topology and cost distribution being from Table 1 and Table 2, respectively, with assumptions t=1 and λ=1.

FIG. 6 is a simplified block diagram of an exemplary computing device that may be configured to implement various functions and processes described herein.

Corresponding reference characters indicate corresponding elements among the view of the drawings. The headings used in the figures do not limit the scope of the claims.

### DETAILED DESCRIPTION

Aspects of the present disclosure relate to a computer-implemented system and associated methods including a structural framework and/or model of an aggregate loss distribution across multiple cyberattacks on a prototypical hospital network. Modeled as a mixed random graph, the hospital network consists of various patient monitoring devices and medical imaging equipment as random nodes to account for the variable occupancy of patient rooms and availability of imaging equipment that are connected by bidirectional edges to fixed hospital and radiological information systems. The disclosed framework accounts for the documented cyber vulnerabilities of a hospital's trusted internal network of its major medical assets. It is believed that no other models of an aggregate loss distribution for cyber risk in this setting exist. The problem in the probabilistic graph theoretical framework is contextualized using a percolation model and combinatorial techniques to compute the mean and variance of the loss distribution for a mixed random network with associated random costs that can be useful for healthcare administrators and cybersecurity professionals to improve cybersecurity management strategies. By characterizing this distribution, pricing cyber risk can also be achieved as an added utility.

In some examples, the computer-implemented system includes a processor in operable communication with a memory, otherwise configured to calculate an aggregate loss distribution associated with at least one cyberattack related to a network. In some examples, the processor generates a plurality of cyberattacks utilizing a random process that models times at which the plurality of cyberattacks occur, creates a plurality of graphs, each graph in the plurality of graphs created for each cyberattack event in the plurality of cyberattack events, each graph comprising a plurality of nodes associated with devices of the network, the plurality of nodes including fixed nodes and random nodes connected by a plurality of edges, each edge in the plurality of edges including a direction and a probability of being open and each node in the plurality of nodes including a cost, selects, for each graph in the plurality of graphs, one or more initial infected nodes in the fixed nodes and the random node of the plurality of nodes for each cyberattack of the plurality of cyberattacks, models a spread of an infection from the one or more initial infected nodes given the direction and the probability of being open for each edge in the graph, and calculates an expected loss and a variation of loss for the plurality of cyberattacks given the plurality of graphs, the initial infected nodes for each graph, and the expected cost of infected nodes after the spread of the infection

### Introduction

Current state of healthcare: In 2019, the United States healthcare sector spending experienced an annual growth of 4.6% reaching $3.8 trillion (Centers for Medicare and Medicaid Services, 2020), and the trend remained unabated to this day. Unfortunately, this expenditure did not correlate with increased levels of cyber protection. In fact, the sector faces increasing financial risk from cyberattacks, which can result in the disruption of computer networks and their systems (Perakslis, 2014). For insurers, cyber risk is the most considered emerging risk (Price Waterhouse Coopers, 2019), and losses of this type are of particular importance. A testament to that is various documented incidents. In particular, for eleven consecutive years, the healthcare industry incurred the highest average data breach cost (IBM Security and Ponemon Institute, 2021), where data breaches are defined as confirmed security events that compromised the integrity, confidentiality, or availability of data by an unauthorized party (Verizon, 2021). These data breaches can last on average 329 days (IBM Security and Ponemon Institute, 2020) with 89% of healthcare organizations having suffered at least one data breach and 45% having at least five data breaches just in 2016 (Paul III et al., 2018). The cost to remediate a data breach averaged $408 per stolen health record in 2018 (Riggi, 2019) and increased to $429 in 2019 (Seh et al., 2020). By 2020, healthcare had the most expensive average cost of a data breach by industry at $7.13 million, which is a 10% increase from 2019 (IBM Security and Ponemon Institute, 2020). The cost continues this increase into 2021 to $9.23 million, which is a 29.5% increase from 2020 (IBM Security and Ponemon Institute, 2021). There have been no signs that the cost will decrease in the foreseeable future. Unfortunately, data breaches are only one consequence of a cyberattack. A cyberattack, especially ransomware which is designed to disable devices until a ransom is paid, is rampant in targeting hospitals. Ransomware attacks have been escalating over the previous years. From 2016 to 2020, there have been 270 ransomware attacks on U.S. healthcare organizations that resulted in a total estimated cost of over $20.8 billion impacting 2,196 hospitals, clinics, and other medical facilities (Bischoff, 2021). These attacks can disrupt hospital operations and patient care even after the contagion is contained, resulting in considerable and cascading losses.

Operation disruption: Disruption of a hospital's normal operation makes it arduous for medical staff to provide treatment and increases costs. In January 2018, Hancock Regional Hospital in Indiana was the victim of a ransomware attack that locked the hospital's computer network (CBS News, 2018), including the hospital's information system and the system's electronic patient records (Hughes, 2018). To unlock their computer systems, they paid an estimated total of $55,000 in ransom (Lovelace Jr. and Gurdus, 2018). For many hospitals, the only way to survive a cyberattack was to shut down their network. As a testament, in October 2020, Sonoma Valley Hospital in California was the victim of a ransomware attack. The hospital responded to the attack by taking all electronic systems offline (Ernst, 2020), resulting in an estimated total cost of $2 million from the ransomware attack (Sonoma Valley Hospital., 2021). That same month, the Canton-Potsdam, Massena, and Gouverneur hospitals, which are all under the St. Lawrence Health Systems, were victims of ransomware attacks (Salama et al., 2020; Cole, 2020) forcing the hospitals to shut down systems; this resulted in electronic health record (EHR) system downtime and ambulances being diverted to nearby hospitals (Davis, 2020) affecting patient care.

Patient care: Cyberattacks may also potentially cause life-threatening situations. In September 2020, paramedics in Germany were transporting a woman to Dusseldorf University Hospital but were redirected to another hospital. This delayed the patient's treatment by an hour because Dusseldorf University Hospital suffered a ransomware attack forcing computer systems to be inoperable and the patient died while in transit (Tidy, 2020; Ralston, 2020). According to German authorities, the medical condition was the sole cause of the death (O'Neill, 2020), but the incident is still under investigation (O'Neill, 2020). There have been similar incidents of ambulances being rerouted such as Centre Hospitalier de Wallonie Picarde in Belgium in January 2021 (Toulas, 2021) and Southern Ohio Medical in November 2021 (Wetsman, 2021a). From these incidents, cyberattacks may cause unexpected issues for patients and their healthcare providers.

Medical Theft: Even after the initial damage and disruption to the hospital, cyberattacks can have lasting complications for the patients and their healthcare providers. Healthcare institutions are frequently targeted by cyberattacks because they have a plethora of highly-valued information (Riggi, 2019); if breached, threaten the patient's privacy due to stolen protected health information (PHI) records (Kumar, 2017). These stolen PHI records can be used to commit medical identity theft (Argaw et al., 2020), which has been amounting to $5.3 billion (Greenborne Networks, 2019) since stolen medical data sells for 10 20 times more than credit card data (Kumar, 2017).

The frequency of successful hacking of patient medical files increased from 55% in 2015 to 64% in 2016 (Paul III et al., 2018). In February 2021, hackers gained access to the computer network of Nocona General Hospital in Texas that compromised thousands of patients and their information, including Social Security numbers, diagnosis information, and procedure descriptions (Texoma News Network, 2021; Nocona General Hospital, 2021). In July 2021, the healthcare provider, Forefront Dermatology, suffered a data breach from hackers gaining access to the provider's network resulting in 2.4 million in individuals' PHI records being exposed (Alder, 2021). With the alarming number of medical records being compromised from these incidents, medical identity theft is a serious concern for patients when their healthcare provider has a data breach. With losses due to healthcare fraud being in the tens of billions of dollars each year (Lacewell, 2020), insurance companies should also be concerned. However, compromised patient records are not the only detrimental impact of an attack.

Heterogeneous and multifaceted losses: Since a cyber-attack may disrupt a hospital's operation, patient care, and compromise medical records, hospitals of any size and specialty may suffer multiple types of loss. Many small clinics and practices have suffered severe cyber-attacks that forced them to permanently close such as Brookside ENT and Hearing Services, a small medical practice in Michigan, due to the financial impact of the attack in March 2019 (McGee, 2019). A few months later, Wood Ranch Medical Center in California was also a victim of a ransomware attack that resulted in the medical center's permanent closure (Wood Ranch Medical, 2019).

Large healthcare networks and hospitals are also victims of catastrophic cyberattacks. In 2017, the United Kingdom's National Health Service suffered a catastrophic ransomware attack by the WannaCry virus (Shah, 2021; Hull, 2020). The virus infected 80 out of the 206 hospitals in the network; over a single week, the cost to the United Kingdom's National Health Service was estimated to be $118 million (Hull, 2020). In October 2020, the University of Vermont Medical Center was victim to a ransomware attack that lasted a month, which could have “had a devastating and long-lasting effect, particularly on cancer patients” (Barry and Perlroth, 2020). The hospital was unable to access scheduling systems, including patient information, cancel procedures, such as MRIs or X-Rays, and unable to process COVID-19 tests (Weiss-Tisman, 2020). Consequently, the ransomware attack cost the hospital approximately $1.5 million a day (Paganini, 2020) for 55 days with an estimated cost of over $82 million, including lost revenue and increased expenses (Lyons, 2020), of which at least $63 million were just recovery costs (Davis, 2021a).

As demonstrated by these incidents, cyberattacks pose significant technical challenges and can cause considerable losses for hospitals of all sizes and specialties with disruption of operations, patient care, recovery costs, and much more. To address the threats and losses, there has been increasing governmental and academic desire to provide resources for managing cyber risk.

Cyber Risk: Managing cyber risk requires an inherent understanding of the potential financial losses and responding effectively to their mitigation. And so, according to The Institute of Risk Management (2018), cyber risk is defined as “any risk of financial loss, disruption or damage to the reputation of an organization from some sort of failure of its information technology systems.” Thus, managing cyber risk comprises many forms such as the utilization of cybersecurity protection for vulnerability mitigation, understanding cyber risk losses on a network, cyber-insurance for minimizing the consequential financial risk, and the use of risk management frameworks for risk identification and assessment.

Cybersecurity protection strategies: There has been a growing set of literature that discusses the cybersecurity vulnerabilities of medical devices (see e.g., Jagannathan and Sorini (2015); Yacioob et al. (2019); Attaallah et al. (2020)). In response, cybersecurity protection strategies have seen a recent increase in publication. Many governmental security standards and information security management practices, such as the International Organization for Standardization (ISO) standard 27002:2013 (International Organization for Standardization (ISO), 2013) and ISO standard 27799:2016 (International Organization for Standardization (ISO), 2016), provide guidance on how best to protect patients' health data. From the academic perspective, Kruse et al. (2017b) provide a review of various cybersecurity protection techniques, particularly firewalls, to protect the confidentiality of patient health records. Additionally, Argaw et al. (2020) provide recommended cybersecurity measures, such as patch management, to mitigate cyber risks in healthcare. Furthermore, Eichelberg et al. (2020) extend these cybersecurity measures to protect medical imaging devices. More recently, He et al. (2021) provides an overview of diverse cybersecurity solutions for protecting healthcare systems and devices. However, the lack of cybersecurity protections may significantly affect the cyber risk exposure of a hospital and thus the financial losses.

Cyber Insurance: As part of a broader risk management strategy for cyber risk (Federal Financial Institutions Examination Council, 2018), cyber insurance may mitigate the financial burden of a cyberattack on a healthcare organization. As described by Da et al. (2021), the academic literature can be broadly categorized into macro-level and micro-level perspectives. The macro-level perspective predicts losses by using historical data of previous data breaches (see e.g., Biener et al. (2015); Eling and Jung (2018); Farkas et al. (2021); Eling et al. (2022b,a)). In contrast, the micro-level perspective considers a network model to predict losses, which is the approach of the framework of the present inventive concept including taking a network approach for pricing cyber risk and thus quantifying potential financial losses for risk frameworks.

Cyber risk frameworks: Many frameworks provide guidance for managing the cyber risk of healthcare organizations. The International Electrotechnical Commission (IEC) produced the IEC 80001 (risk management of medical devices on a network) standard to address the safety, effectiveness, and security of medical devices integrated into a network (Alwi et al., 2020; Subhan, 2016). Additionally, two other popular cybersecurity frameworks for healthcare organizations are provided by the National Institute of Standards and Tecfahnology (NIST) and the Health Information Trust Alliance (HITRUST) (Healthcare Information and Management Systems Society, 2018). The NIST framework provides a set of guidelines for mitigating cyber risks by creating a taxonomy and methodology to manage those risks (National Institute of Standards and Technology (NIST), 2018). Similarly, the framework from HITRUST provides a comprehensive methodology for regulatory compliance and managing cyber risk (Health Information Trust Alliance, 2021). However, despite not quantifying the cyber risks, these frameworks guide cybersecurity professionals in defining and assessing them, especially for medical devices. And so, for the protection of the medical device, it is vital to ensure the medical device's connected network is also secured (Attaallah et al., 2020).

Network resilience describes the network's ability to function in the presence of adverse conditions (Moore and Cho, 2019). Therefore, managing cyber risk should consider the entire network structure to account for the cyber resiliency of the healthcare organization's network and connected devices (Antonio and Indratno, 2021; Amin, 2019). For example, Welburn and Strong (2022) and Crosignani et al. (2021) showed that the immediate costs associated with a cyberattack are greatly amplified by the increasing number of third-party connections to an organization's network. This indicates that overlapping software applications, vendors, and digital network structures may greatly enhance the propagation of a cyberattack leading to greater losses. Thus, the landscape of heterogeneity across the network structure may impact its resiliency, whose understanding is essential for an optimal risk management strategy (Amin, 2019), especially in the hospital infrastructure setting. Unfortunately, in this regard, there is a lack of literature and associated technologies on cyber risk management for healthcare.

### System (100)

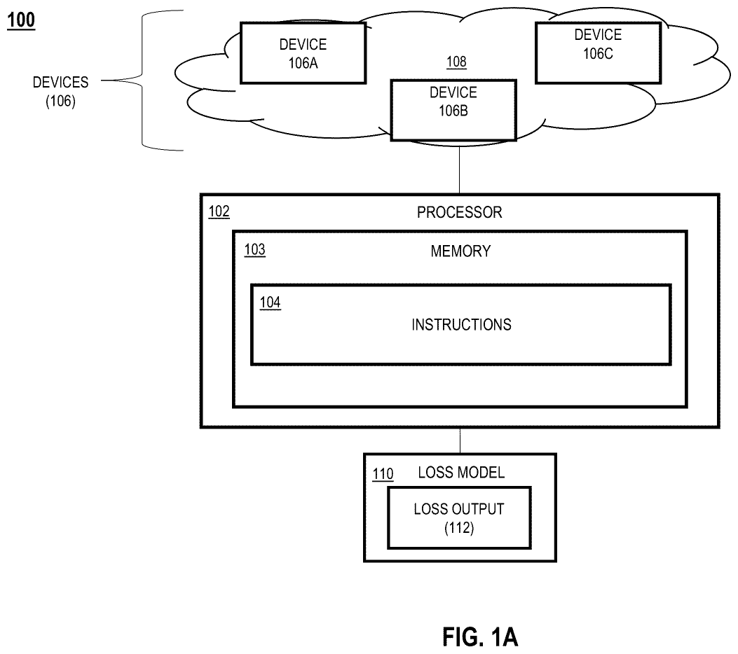

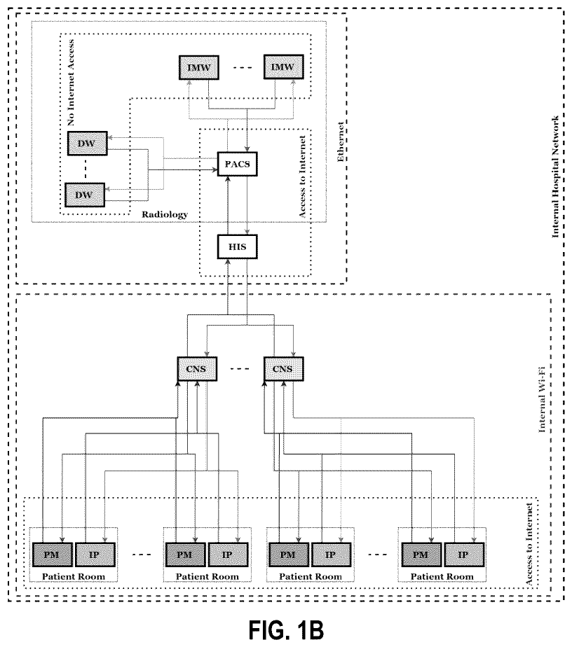

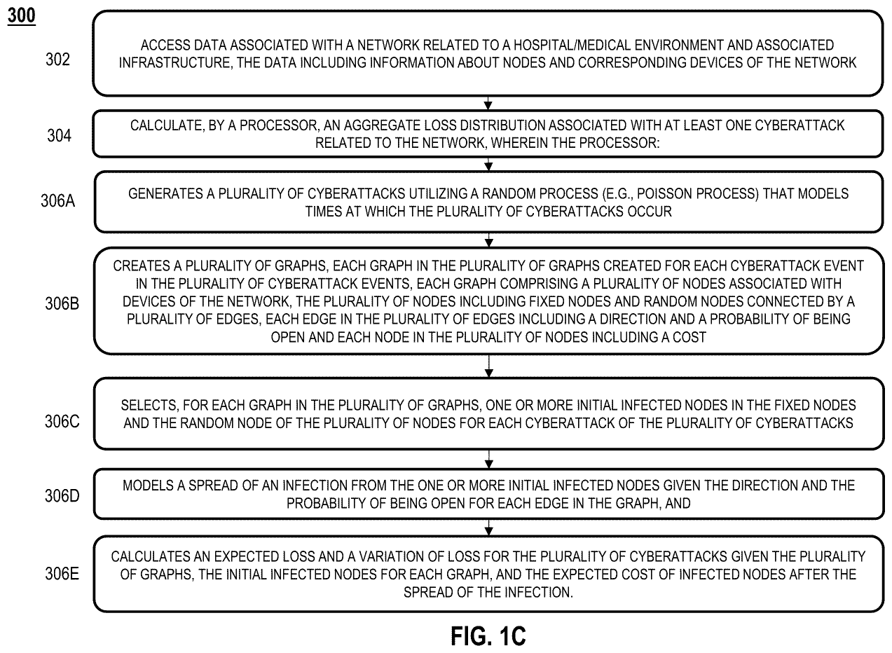

Referring to FIG. 1A, examples of a system described herein may take the form of a computer-implemented system, designated system 100, configured for cyber-loss modeling. In general, as indicated, the system 100 includes at least one processor 102 or processing element in communication with a memory 103 storing or having access to instructions 104 (defining computational steps, operations and the like for modeling or executing the modeling framework as described). The system can further include a plurality of devices 106 of a network 108; the processor 102 being operable to access information about the devices 106 as further described herein. The processor is configured for cyber-risk and/or cyber-loss modeling, e.g., the processor 102 can execute the instructions 104 stored in the memory 103 including any form of machine-readable medium for executing related functions and other related aspects described herein. For example, the processor 102, via execution of instructions 104, provides a loss model 110 for a mixed random network like that of a prototypical hospital with a contagion spreading throughout the internal network, as further described herein.

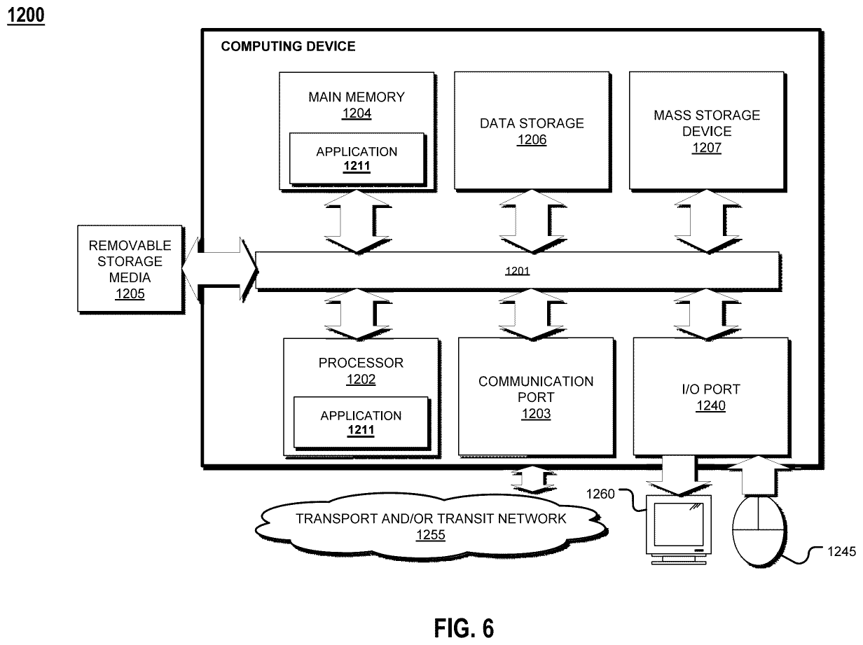

The instructions 104 may be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, one or more of the features for cyber-risk and/or cyber-loss modeling and processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103 and/or the memory of computing device 1200 of FIG. 6), and the processor 102 performs the tasks defined by the code.

Since hospitals, like many other critical infrastructures, may have permanently affixed assets such as hospital and radiological information systems that are the cornerstones of the network and may have fluctuations in the usage of other components such as available patient rooms and medical imaging equipment, we model the dynamical nature of a prototypical hospital as a mixed random network by having fixed nodes on a random graph. More precisely, devices 106, which include the various patient monitoring devices and medical imaging equipment of the hospital, are represented by a random number of nodes to account for the variability of the occupancy of patient rooms and the availability of imaging equipment that are connected by bidirectional edges to fixed hospital and radiological information systems. Therefore, we account for various sizes and specialties of hospitals. Due to the variability of the devices 106 and their connections in this type of mixed random network, we incorporate bidirectional edges for each group of components. And so, the proposed framework consists of the core components of the hospital's internal network infrastructure containing devices 106 (e.g., medical devices) with documented cyber vulnerabilities and systems known to be targets of cyberattacks.

To model the spread of a cyberattack on the network, each cyberattack is modeled by a contagion process starting from a random node and proceeding away from this source via the edges with certain probabilities that depend on the direction in which the edges are compromised. By taking bond percolation, which accounts for stochasticity and network structure as the model of the contagion of a cyberattack, we take a perspective which is believed to be relevant to not only cybersecurity and network specialists but also to actuaries and hospital management teams. With each medical device associated with random costs, the loss resulting from the cyberattack is then defined as the total cost of all the nodes reached by the contagion and the aggregate loss is the cumulative loss of all the cyberattacks up to a fixed time (collectively “loss output” 112 in FIG. 1A). Thus, the system 100 provides a technical solution to the technical problems described above by providing a loss model (110) for a mixed random network like that of a prototypical hospital with a contagion spreading throughout the internal network that can be used as the foundation for other networks with mixed random components and differing connections.

FIG. 1C is an example implementation of the model of FIG. 1A. As indicated in blocks 302 and 304, the processor 102 accesses information about the network 108 including the devices 106 and performs a series of operations (blocks 306A-306E) to compute an aggregate loss distribution for the network 108. The example operations shown include non-limiting example functions related to the loss model 110 described herein to assess possible cyber risk associated with hospital/medical environments and/or infrastructure.

Below, additional details including analytical results and their numerical implications related to the mean and variance of the aggregate loss distribution for multiple cyberattacks are provided. This information and work paves the way for risk management teams to make more informed investments in the cybersecurity protection of hospital infrastructure.

### Devices (106)

Devices 106 include one or more medical and/or non-medical devices as there may be many varieties and combinations of these devices used in hospitals that all pose as possible attack vectors for hackers. This section describes exemplary medical devices that are typically seen in a hospital and their underlying network connections (see FIG. 1B). With the layout of a hospital in mind, we further investigate the cybersecurity risks a hospital may face.

### Medical Devices:

One of the most technological and important departments within a hospital is the radiology department. A typical radiology department consists of
(1) Image Modality Workstations (IMW) to control medical imaging devices such as MRI machines and CT scanners (Huang, 2009; Mirsky et al., 2019),
(2) Diagnostic Workstations (DW), which may also be known as PACS workstations, allow a radiologist to interpret the images or another medical professional to view the images (Huang, 2009), and a
(3) Picture Archiving and Communication Systems (PACS) to send, receive, and store medical images (Huang, 2009; Health Sector Cybersecurity Coordination Center, 2020).

There are other hospital departments such as general surgery or ophthalmology that may use the DWs to remotely access medical images (Quiles et al., 2005; Dallessio, 2006). For hospitals to operate efficiently and provide swift patient care, hospitals use the
(4) Hospital Information System (HIS), is a computerized management system for supporting clinical and medical patient care activities such as automation of patient registration, admissions, discharges, and transfers (Huang, 2009; Feng, 2020).

There are other information systems that hospitals utilize to facilitate operations such as the Radiology Information Systems (RIS) which contains patient data pertaining to medical images and patient scheduling for acquiring a medical image (Huang, 2009). The RIS system can be embedded with the HIS system to be one single component since it is a subset of the HIS (Huang, 2009; Feng, 2020). Other information systems, such as those for laboratory or pathology, are under the umbrella of the HIS system, which also administers the hospital's daily business transactions and provides remote access to patient clinical results (Huang, 2009; Mehdipour and Zerehkafi, 2013). The EHR system, which contains all of the hospital's electronic patient records, can be integrated with the RIS and HIS systems (Huang, 2009; Feng, 2020). To monitor patients during their stay at a hospital, the patient monitoring process consists of
(1) Central Nursing Stations (CNS) to allow a single medical professional to collect patient information, such as temperature and heartbeat, and monitor multiple patients (U.S. Food and Drug Administration (FDA), 2020; Sun et al., 2020; McKee, 2018),
(2) Patient Monitors (PM) to remotely monitor the patient's condition such as displaying heartbeat and blood pressure (Benyon, 2020; Sweeney, 2018; Leyden, 2018; McKee, 2018), and
(3) Infusion Pumps (IP) intravenously deliver fluids, such as medication, to the patient in controlled amounts (U.S. Food and Drug Administration (FDA), 2018).

Therefore, a prototypical hospital would consist of IMWs, DWs, a PACS system, a HIS system, CNSs, PMs, and IPs along with their various interconnections.

### Connectivity:

In the radiology department, the IMWs can send and receive images from the PACS (Davis, 2018; Huang, 2009; Mah and Higgins, 2012). Radiologists, from their DWs, download and upload their diagnoses to the PACS (Huang, 2009; Mirsky et al., 2019). The PACS can send the diagnosis to the HIS as part of the patient's health record and the PACS can receive patient information from the HIS (Huang, 2009). To frequently update the patient's health record, the CNS can upload data to the HIS and download patient information (Mehdipour and Zerehkafi, 2013; Poissant et al., 2005). The patient information is sent from the PMs and IPs in the patient rooms connected to a CNS (Mokarami et al., 2021; Sun et al., 2020). These bidirectional connections can be visualized in FIG. 1B (for more information on these connections, see Appendix A (below)). With these various medical devices connected to the hospital network, there are ample ways a hacker can gain internal access.

### Cybersecurity Risks

Hospitals and their devices are increasingly exposed to various types of cybersecurity risks, such as data security, data privacy, and system security. Although data security and data privacy are closely related, they are distinguishable. Data privacy is an “individual's right to maintain control over and be free from intrusion into their private data and communications” (U.S. Department of Health and Human Services (HHS), 2020). Since patients trust hospitals to maintain their private health information, hospitals must adhere to Health Insurance Portability and Accountability Act (HIPAA) laws and regulations. In contrast, data security relates to the “protection of data against unauthorized access” (U.S. Department of Health and Human Services (HHS), 2020). Therefore, the HIPAA Security Rule requires that appropriate cybersecurity protection is in place to ensure the confidentiality and security of patient health data (U.S. Department of Health and Human Services (HHS), 2020). Furthermore, data security is also interlaced with a system's security (May and Denecke, 2022), which we consider in our framework.

In the context of healthcare, a device 106 such as a computing device/system can be a computer in the hospital's network or a medical device (Grimes and Wirth, 2021). And so, system security includes the security of the system's operating software and access control to the device (Zhang, 2022). However, there should some distinction between the security of a computer and that of a medical device. Medical devices, such as IPs, may not allow for the addition of third-party software, such as anti-virus or anti-malware programs, because the protection could negatively impact the medical device's ability to operate effectively (O'Brien et al., 2018). Because of this, it is imperative that hospitals apply the medical device's patching and updates from the manufacturer as soon as possible (O'Brien et al., 2018; Forescout Research Labs, 2020) since a compromised medical device may lead to more severe risks (Somasundaram and Thirugnanam, 2021) and thus higher losses. Therefore, the vulnerabilities of interconnected medical devices in a hospital network pose serious cyber risks.

To address these concerns, network security considers the protection of the network (Riyanti et al., 2019) to safeguard the confidentiality, integrity, availability, and authenticity of the information transmitted (Yi and Yifei, 2010; Yan et al., 2015). To achieve this, network security consists of technologies, such as firewalls (Kruse et al., 2017b) and intrusion detection systems (IDS) (Yan et al., 2015; Siyuan et al., 2001), to mitigate the spread of the contagion from a cyberattack throughout the hospital's network, which this framework model (for detailed information on the cyber vulnerabilities of healthcare and each medical device, including vulnerability data from the National Vulnerability Database, see Appendix B).

### Stochastic Modeling of Cyber Risk of Hospital Infrastructure

The following is devoted to the description of a stochastic model developed to study the distribution of the aggregate loss. In one example, the model is a continuous-time Markov chain denoted by (Lₜ) that records and adds up the losses resulting from all the cyberattacks that occur by arbitrary but fixed time t. For the purpose of loss assessment, the objective is to compute the mean and the variance of the stochastic process Lₜ.

The process is built from the combination of various components. The first component is a Poisson process modeling the times at which cyberattacks occur. The second component is a mixed-random graph, which is comprised of fixed and random nodes, modeling the hospital's infrastructure during the cyberattacks. For the fixed components, the cornerstone devices of a hospital network are the PACS and HIS systems. And to account for various sizes of hospitals based on available patient rooms and medical imaging devices, the random nodes are the CNSs, PMs, IPs, IMWs, and DWs. Lastly, a bidirectional bond percolation process on this graph models the contagion of the cyberattack.

We now describe each of these components in detail. To begin with,
1. we let (Nₜ) be a Poisson process with intensity λ and assume that the jth cyberattack occurs at the jth arrival time of this process, defined as

T^{j}=inf {t:Nₜ=j} for j=1,2,

In other words, the times between consecutive cyber-attacks are independent exponential random variables with the same parameter A, meaning that

P(T¹>s)=P(T^{j+1}−T^{j}>s)=e^{-λs}

for all s>0 and j=1,2, . . . . At the time of the jth cyberattack, we assume that
2. the infrastructure of the hospital is represented by the realization G^{j}=(V^{j}, E^{j}) of a random graph.

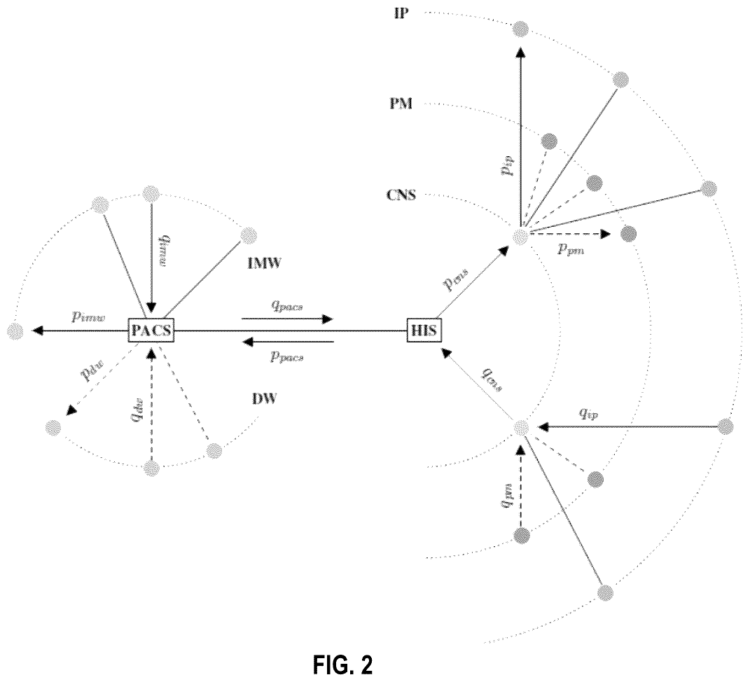

The topology of this random graph is depicted in FIG. 2. The choice of a random graph rather than a fixed deterministic graph is due to the dynamic nature of some of the components of the hospital which are therefore more realistically described by random variables rather than fixed numbers. Realizations at different times are assumed to be independent and identically distributed. Motivated by the information presented above about the hospital medical device assets, the vertex set V^{j} is partitioned into seven groups of labeled vertices. More precisely, we let Vᵢ^{j} be the vertices in group i ∈ {1,2, . . . , 7} where

| | | | |
|---|---|---|---|
| IMW = 1, | DW = 2, | PACS = 3, | HIS = 4, |
| CNS = 5, | PM = 6, | IP = 7 | |

corresponding to the seven groups that appear in FIG. 1B for a prototypical hospital with the corresponding topology depicted in FIG. 2.

Even though FIG. 2 provides a visualization of the topology of the graph, to be fully rigorous and to illustrate further, we now give a more formal description.
The two components PACS and HIS correspond to two vertices connected by a single edge.
The vertices in IMW and DW are each connected to PACS by an edge and the number of such vertices is random with mean μ_{imw}=μ₁ and μ_{dw}=μ₂, respectively.
Similarly, the vertices in CNS are each connected to HIS by an edge and the number of such vertices is again random with mean μ_{cns}=μ₅.
Finally, the vertices in PM and IP are each connected to exactly one vertex in CNS and the number of such vertices connected to the same vertex is random with mean μₚₘ=μᵢₚ=μ. Due to the possible correlations between groups PM and IP, it is also assumed that the number of vertices in PM and the number of vertices in IP connected to the same vertex in CNS are equal.

Note that this construction and the topology of the graph are indeed consistent with the hospital medical device assets along with the way they interact, as described above.

Now that the times of the cyberattacks and the infrastructure of the hospital at the times of the attacks are defined, we can describe the shape of the cyberattacks and the resulting loss. Once a realization of the graph is fixed, we assume that the cyberattack starts at
3. a vertex x^{j} ∈ Vᵢ^{j} chosen at random.

As we will see later, due to the spherical symmetry of our model, the mean and variance of the loss resulting from a single cyberattack depend on the group of vertices the attack starts from but not on the specific choice of a vertex within this group. In particular, the model is well defined by simply assuming that the attack starts from group i(x^{j} ϵVᵢ^{j}) with probability a where

a₁+ . . . +a₇=1.

To model the spread of the cyberattack from its source, we use bidirectional bond percolation. More precisely, we assume that
4. the edges are independently open with probabilities that depend on their location and direction.

Each bidirectional edge shown in FIG. 2 is identified as two directed edges between components. The set of bidirectional edges is partitioned into six groups as depicted in FIG. 2.
An IMW is connected to the PACS with a directed edge being open with probability p_{imw}=p₁ in one direction and with probability q_{imw}=q₁ in the other direction.
A DW is connected to the PACS with a directed edge being open with probability p_{dw}=p₂ in one direction and with probability q_{dw}=q₂ in the other direction.
The HIS is connected to the PACS with a directed edge being open with probability p_{pacs}=p₃ in one direction and with probability q_{pacs}=q₃ in the other direction.
The HIS is connected to a CNS with a directed edge being open with probability p_{cns}=p₅ in one direction and with probability a q_{cns}=q₅ in the other direction.
A CNS is connected to a PM with a directed edge being open with probability pₚₘ=p₆ in one direction and with probability qₚₘ=q₆ in the other direction.
A CNS is connected to an IP with a directed edge being open with probability pᵢₚ=p₇ in one direction and with probability qᵢₚ=q₇ in the other direction.

As a general rule, if the directed edge is oriented away from the HIS vertex then it is open with probability pᵢ whereas if the directed edge is oriented toward the HIS vertex then it is open with probability qᵢ, as shown in FIG. 2. The set of vertices from group i that are hacked is then defined as the intersection of group i and the oriented bond percolation cluster starting from the source:

[symbol]

ᵢ^{j}={y ϵ Vᵢ^{j}: there is a directed path of open edges x^{j}→y} for i=1, 2, . . . , 7.

In particular, the set of vertices that are compromised is the union of the seven sets above. This defines the shape of the cyberattack. The last step is to assign a cost to this set. To do this,
5. we let C_{y}^{j} be random costs attached to vertices y ∈ V^{j}

and assume that the random variables C_{y}^{j} are independent with the same distribution Cᵢ for all y in group i but because the elements from each of the seven groups may have significantly different costs, the seven distributions C₁, C₂, . . . , C₇ may differ. Then, the loss resulting from vertices in group i being hacked is defined as the sum of the costs of all the vertices in group i that have been hacked, and the total loss resulting from the jth cyberattack is defined as the sum of the costs of all the vertices that have been hacked. In equations, these two quantities can be written as

$$\\ \overline{{C}_{i}^{j}} = {\sum }_{y ∈ {𝒞}_{i}^{j}} {C}_{y}^{j} and {C}^{j} = {\sum }_{i = 1}^{7} \overline{{C}_{i}^{j}} = {\sum }_{i = 1}^{7} {\sum }_{y ∈ {𝒞}_{i}^{j}} {C}_{y}^{j} .$$

Finally, the random variable Lₜ is defined as the aggregate loss caused by all the cyberattacks that occur up to time t. Using the previous two equations and the fact that the number of cyberattacks up to time t is given by the value Nₜ of the Poisson process, we have

$${L}_{t} = {\sum }_{j = 1}^{{N}_{t}} {C}^{j} = {\sum }_{j = 1}^{{N}_{t}} {\sum }_{i = 1}^{7} \overline{{C}_{i}^{j}} = {\sum }_{j = 1}^{{N}_{t}} {\sum }_{i = 1}^{7} {\sum }_{y ∈ {𝒞}_{i}^{j}} {C}_{y}^{j} .$$

For the purpose of loss distribution characterization and risk pricing, the main objective is to compute the expected value and variance of the aggregate loss Lₜ. Because the realizations of the mixed random graph, oriented bond percolation process, and costs across the graphs are independent and identically distributed at each cyberattack, the financial losses resulting from different cyberattacks are independent and identically distributed as well so, to simplify the notation, we drop from now on the superscript j that refers to the number of attacks. In particular, the mean and variance of the aggregate loss Lₜ can be deduced from the mean and variance of the loss resulting from a single contagion.

### Analytical Results

In this section, we compute the mean and variance of the aggregate loss as a function of the parameters of the system. To be more precise, we compute explicitly the mean for the general model described in the previous section while we compute the variance in the special case where the infrastructure of the hospital is represented by a deterministic graph since the approach is too tedious and arduous on a random graph but not impossible. Using conditioning techniques, we prove that the aggregate loss can be expressed as a function of the loss resulting from a single cyberattack which, in turn, can be expressed as a function of the number of vertices from group i that are compromised during the attack. Also, we let

Sᵢ=card ( [symbol] ᵢ^{j})=card ( [symbol] ᵢ) for i=1, 2, . . . , 7

to be the number of vertices from group i that is hacked. To complete our analysis, the last step will be to use combinatorial arguments to compute the expected values E(Sᵢ) and E(SᵢSⱼ). The relationship between the aggregate loss up to time t and the loss resulting from a single attack is given by the following lemma.—The mean and variance of Lₜ are

E(Lₜ)=λtE(C) and Var (Lₜ)=λtE(C²).

Proof An example proof is the proof of (1) and (2) in Jevtić and Lanchier (2020) Q.E.D.

Motivated by Lemma 4, the next step is to compute the first moment and the second moment of the cost C resulting from a single cyberattack. These two quantities can be expressed using the expected values E(Sᵢ) and E(SᵢSⱼ), as shown in the next lemma.— The first and second moments of C are the sizes, we get

$$E ( C ) = {\sum }_{i = 1}^{7} E ( {S}_{i} ) E ( {C}_{i} ) and$$

$$E ( {C}^{2} ) = {\sum }_{i = 1}^{7} ( E ( {S}_{i} ) E ( {C}_{i}^{2} ) + E ( {S}_{i} ( {S}_{i} - 1 ) ) {E ( {C}_{i} )}^{2} ) + {\sum }_{i \neq j} E ( {S}_{i} {S}_{j} ) E ( {C}_{i} ) E ( {C}_{j} ) .$$

Proof Using the linearity of the expected value and conditioning on

$$\begin{matrix}E ( C ) = E ( {\sum }_{i = 1}^{7} \overline{{C}_{i}} ) = {\sum }_{i = 1}^{7} E ( E ( \overline{{C}_{i}} \vert {S}_{i} ) ) \\ = {\sum }_{i = 1}^{7} E ( {S}_{i} E ( {C}_{i} ) ) = {\sum }_{i = 1}^{7} E ( {S}_{i} ) E ( {C}_{i} )\end{matrix} .$$

Conditioning on the size and using the independence of the local costs, we get

$$\begin{matrix}E ( {\overline{C}}_{i}^{2} ) = E ( {( {\sum }_{y ∈ {𝒞}_{i}} {C}_{y} )}^{2} ) = E ( E ( {\sum }_{y ∈ {𝒞}_{i}} {C}_{y}^{2} + {\sum }_{y \neq z} {C}_{y} {C}_{z} \vert {S}_{i} ) ) \\ = E ( {S}_{i} E ( {C}_{i}^{2} ) + {S}_{i} ( {S}_{i} - 1 ) {E ( {C}_{i} )}^{2} ) \\ = E ( {S}_{i} ) E ( {C}_{i}^{2} ) + E ( {S}_{i} ( {S}_{i} - 1 ) ) {E ( {C}_{i} )}^{2}\end{matrix}$$

while, for all i≠j,

$$\begin{matrix}E ( \overline{{C}_{i} {C}_{j}} ) = E ( ( {\sum }_{y ∈ {𝒞}_{i}} {C}_{y} ) ( {\sum }_{z ∈ {𝒞}_{j}} {C}_{z} ) ) \\ = E ( E ( ( {\sum }_{y ∈ {𝒞}_{i}} {C}_{y} ) ( {\sum }_{z ∈ {𝒞}_{i}} {C}_{z} ) \vert {S}_{i} {S}_{j} ) ) \\ = E ( {S}_{i} E ( {C}_{i} ) {S}_{j} E ( {C}_{j} ) ) = E ( {S}_{i} {S}_{j} ) E ( {C}_{i} ) E ( {C}_{j} )\end{matrix} .$$

It follows that

$$\begin{matrix}E ( {C}^{2} ) = E ( {( {\sum }_{i = 1}^{7} \overline{{C}_{i}} )}^{2} ) = E ( {\sum }_{i = 1}^{7} {\overline{C}}_{i}^{2} + {\sum }_{i \neq j} \overline{{C}_{i} {C}_{j}} ) \\ = {\sum }_{i = 1}^{7} ( E ( {S}_{i} ) E ( {C}_{i}^{2} ) + E ( {S}_{i} ( {S}_{i} - 1 ) ) {E ( {C}_{i} )}^{2} ) + {\sum }_{i \neq j} E ( {S}_{i} {S}_{j} ) E ( {C}_{i} ) E ( {C}_{j} )\end{matrix} .$$

This completes the proof.

In view of Lemmas 4 and 4, in order to compute the mean and variance of the aggregate loss, the next step is to compute the expected value of the random variables Sᵢ and SᵢSⱼ. To do this, let
x ∈ Vₖ for group k and
ξ(y)=1 {vertex y is infected} for all y ∈ V.

Because the graph is connected and has no cycle, for all y ∈ V, there is a unique path going from vertex x to vertex y and we write x→y this unique path. Then, for each group i,

$$\begin{matrix}{E}_{x} ( {S}_{i} \vert G ) = {E}_{x} ( {\sum }_{y ∈ {V}_{i}} ξ ( y ) \vert G ) = {\sum }_{y ∈ {V}_{i}} {P}_{x} ( ξ ( y ) = 1 ) \\ = {\sum }_{y ∈ {V}_{i}} P ( x \to y is open )\end{matrix} . \qquad ( 1 )$$

Using this equation, we can compute the conditional expectation of the number of vertices in group i that are hacked given that the cyberattack starts from a vertex in group k, a quantity that we denote by Eₖ (Sᵢ). We refer the reader to Appendix C for the table of the explicit results for the first moment.

We now look at the expected value of the products SᵢSⱼ that appear in the expression of the variance of the aggregate loss. As previously explained, we assume in this case that the graph is deterministic and homogeneous in the sense that we now think of μ₁, μ₂, μ₅ and μ as fixed integers rather than the mean of a random number of vertices. The percolation process, however, is still random. This scenario does not account for the potential variability of the topology of the infrastructure but using a coupling argument (constructing two processes with the same parameters but on two different graphs (Lanchier, 2017), it can be proved that adding edges can only increase the expected number of vertices that are hacked. In particular, the actual value of Eₖ (SᵢSⱼ) in the context of random graphs can be bounded from below, respectively, from above, by its counterpart for the process on a deterministic graph that is contained, respectively, the random graph. Note that, for all i, j, k=1,2, . . . , 7 (possibly equal),

$$\begin{matrix}{E}_{x} ( {S}_{i} {S}_{j} ) = {E}_{k} ( {S}_{i} {S}_{j} ) = {E}_{x} ( ( {\sum }_{y ∈ {V}_{i}} ξ ( y ) ) ( {\sum }_{z ∈ {V}_{j}} ξ ( z ) ) ) \\ = {\sum }_{y ∈ {V}_{i}} {\sum }_{z ∈ {V}_{j}} {P}_{x} ( ξ ( y ) = ξ ( z ) = 1 ) \\ = {\sum }_{y ∈ {V}_{i}} {\sum }_{y ∈ {V}_{j}} P ( x \to y and x \to z are open )\end{matrix} . \qquad ( 2 )$$

As for the mean, using this equation, we can compute the conditional expectation of the number of vertices in group i times the number of vertices in group j that are hacked given that the cyberattack starts from a vertex in group k. We refer the reader to Appendix D for the tables of the explicit results for the second moment.

To conclude this section, we explain how an actual hospital can use our analytical results (along with data that is hospital-specific) to compute the mean and variance of the aggregate loss. To begin with, combining the first part of Lemma 4 and the first part of Lemma 4, and conditioning on the group from the cyberattacks start from, we obtain

$$\begin{matrix}E ( {L}_{t} ) = λ tE ( C ) = λ t {\sum }_{k = 1}^{7} E ( C \vert x ∈ {V}_{k} ) P ( x ∈ {V}_{k} ) \\ = λ t {\sum }_{k = 1}^{7} {\sum }_{i = 1}^{7} {a}_{k} {E}_{k} ( {S}_{i} ) E ( {C}_{i} )\end{matrix} . \qquad ( 3 )$$

Similarly, by combining the second part of both lemmas, we get

$$\begin{matrix}Var ( {L}_{t} ) = λ tE ( {C}^{2} ) = λ t {\sum }_{k = 1}^{7} E ( {C}^{2} \vert x ∈ {V}_{k} ) P ( x ∈ {V}_{k} ) \\ = λ t {\sum }_{k = 1}^{7} {\sum }_{i = 1}^{7} {a}_{k} ( {E}_{k} ( {S}_{i} ) E ( {C}_{i}^{2} ) + {E}_{k} ( {S}_{i}^{2} - {S}_{i} ) {E ( {C}_{i} )}^{2} ) + \\ λ t {\sum }_{k = 1}^{7} {\sum }_{i \neq j} {a}_{k} {E}_{k} ( {S}_{i} {S}_{j} ) E ( {C}_{i} ) E ( {C}_{j} )\end{matrix} . \qquad ( 4 )$$

Replacing Eₖ (Sᵢ) and Eₖ (SᵢSⱼ) by the terms of Tables 4-11 (see Appendices C and D) in equations (3) and (4) gives explicit expressions of the mean and variance of the aggregate loss. Here, if one looks closely, the heterogeneity of the network structure coupled with the properties of the contagion flow modeled via the bond percolation process is intimately interconnected with the variance of the losses and to a lesser degree with the mean. Specifically, the mean and variance of the aggregate loss are expressed as a function of the parameters of the framework which are divided into five categories corresponding to the five components of the model introduced in the previous section:
the frequency of the cyberattacks: the parameter λ,
the (mean) number of components in each group describing the infrastructure of the hospital: the parameters μ₁, μ₂, μ₅ and μ,
the distribution of the source: the parameters a₁, a₂, . . . , a₇
the cyber vulnerability of the hospital: the parameters pᵢ and qᵢ for i=1,2,3,5,6,7,
the first and second moments of the cost of each medical component in the hospital: the first and second moments of the random variables C₁, C₂, . . . C₇.

Estimating these five sets of parameters cannot be done using a mathematical analysis because they are specific to each hospital. However, one can have an approximation of the first and third sets of parameters (the frequency and the source of the cyberattacks) by relying on past cyberattack data. Furthermore, the fourth set of parameters measuring the cyber vulnerability of a hospital is less obvious but can be obtained from the vendor and model-specific medical device's vulnerabilities in conjunction with the hospital's own internal cybersecurity protocols and protection. A healthcare risk management team can easily estimate the second and fifth sets of parameters (the number and cost of the various components in a particular hospital of interest). We demonstrate the estimation of the second and fifth sets of parameters by using publicly available data in the following section.

### Informed Parameter Estimates

In this section, we estimate the parameter values for the number of components in each group of a prototypical hospital and their associated cost distributions from publicly available data.

Number of medical devices. Hospitals vary in size from the number of patient rooms to the number of imaging scanners. A single hospital can have over 1,000 staffed beds, such as Barnes-Jewish Hospital in Missouri, or as few as 21 staffed beds, such as John Paul Jones Hospital in Alabama (American Hospital Directory, 2021). However, cyberattacks do not distinguish by specialty, size, or affiliation of a hospital. In 2014, a convicted hacker launched a massive distributed denial-of-service (DDoS) attack against Boston Children's Hospital that resulted in at least $300,000 in damages and an additional $300,000 loss in donations (U.S. Department of Justice: District of Massachusetts, 2018). In May 2021, two hospitals in the University of Florida Health network suffered a cyberattack (Dahm, 2021). Recently, in June 2021, Stillwater Medical Center, a not-for-profit community health system in Oklahoma, suffered a ransomware attack that shut down its EHR system (Davis, 2021b). As described by these incidents, many different types of hospitals are susceptible to cyberattacks. In this paper, we consider the distribution of the number of components in each group for a prototypical hospital. The publicly available data suggests that the number of components in each group within U.S. hospitals can be specified as in Table 1 with a fixed PACS and HIS system (sources referenced in the table).

Cost distributions. The primary costs of a cyberattack are damage to equipment, the loss of information, loss of revenue, and business interruption (Paul and Wang, 2019), including diminished employee productivity (Ponemon Institute, 2020).

Business interruption. Disruption of hospital operations may force resources away from patient care and thus negatively impact medical personnel productivity (Lee and Choi, 2021). In a hospital environment, diminished productivity is viewed as the increased time it takes to complete routine tasks (Dempsey and Reilly, 2016), such as nurses taking longer than usual to assist patients or updating patient records. Because of this, it is estimated that cyberattacks cost healthcare organizations $9 billion a year due to recovery and diminished productivity (CNBC, 2020). As a recent testament in May 2021, two hospitals in Florida had to shut down portions of their IT network, resulting in nurses updating patient records by hand (Abrams, 2021). Consequently, the diminished productivity may further negatively impact the revenue of the hospital.

TABLE 1
The expectation and deviation of the number of each component
within a hospital (sources listed in the table).

| | Expectation | Deviation | |
|---|---|---|---|
| Component | of Number | of Number | Sources |
| IMW | 8.71 | 2.35 | Organisation for Economic Cooperation and Development |
| | | | (OECD) (2020e, d, b) |
| DW | 12.89 | 6.17 | Rosenkrantz et al. (2016); United States Census (2021) |
| CNS | 8.19 | 24.55 | University of North Carolina Medical Center (2016); U.S. |
| | | | Department of Health and Human Services (HHS) (2021) |
| PM/IP | 20.29 | 6.98 | Brewer et al. (2018); U.S. Department of Health and Human |
| | | | Services (HHS) (2021) |

Loss of revenue. Disrupting a hospital's operation may also lead to a loss of revenue for the hospital due to downtime. A disruption in hospital operations can cost $45,700 per hour of downtime (Mitchell, 2021a), so a single cyberattack can easily cost a hospital $918, 000 just in loss of revenue (Connolly et al., 2018). As a testament to this, there have been many incidents. In September 2020, Universal Health Services, whose all 250 U.S. healthcare facilities include hospitals and clinics, was the victim of a ransomware attack (Bajak, 2020; Collier, 2020). All 250 facilities had computer systems either slowed or forced completely shutdown resulting in significant downtime of operations (Bajak, 2020) with $67 million in losses (Lyngaas, 2021; Davis, 2021a). The ransomware attack on the University of Vermont Medical Center in October 2020 cost the hospital approximately $1.5 million a day (Paganini, 2020) for 55 days with an estimated cost of over $82 million, including lost revenue and increased expenses (Lyons, 2020). In May 2021, Scripps Health, a nonprofit healthcare system, suffered a ransomware attack that resulted in 147,267 patient records being breached and $112.7 million in damages, including lost revenue (King, 2021; Landi, 2021). Furthermore, a hospital may continue to lose revenue due to the cost of replacing damaged equipment from a cyberattack.

Damage to equipment. A cyberattack can damage various devices on the hospital network, resulting in recovery costs for the hospital. After the ransomware attack in 2020, administrators at the University of Vermont Health Network acknowledged that restoring services proved far more challenging than they expected (Barry and Perlroth, 2020). In particular, many professionals had to rebuild and clean 1,300 servers and 5,000 computers (Barry and Perlroth, 2020). Another instance, in October 2020, the Sky Lakes Medical Center in Oregon was victim to the Ryuk ransomware (Jickling, 2020; National Broadcasting Company, 2020; Dillemuth, 2020). It took about a month to restore the hospital to normal operations but forced the hospital to rebuild its network with new servers and 2,500 new computers resulting in $10 million in damages, including lost revenue due to downtime (Evans and McMillan, 2021). In May 2021, Ireland's Health Service Executive, which is the public healthcare system, suffered a ransomware attack that resulted in compromised patient data and most of the country's hospitals without working computers for over a week. It took four months to fully recover with systems still vulnerable to more severe attacks (Morgan, 2021; BBC News, 2021; Chambers and Reevell, 2021; Corera, 2021). The immediate cost of recovery totaled $120 million, but other expenses such as upgrading and replacing systems brought the total cost to an estimated $600 million for the attack (Asokan, 2021; Davis, 2021a). The compromise of a medical component may further jeopardize the privacy of patient medical data.

Compromised patient records. Since hospitals are responsible for their patients' privacy, a hospital may be fined for violating HIPAA or the General Data Protection Regulation (GDPR) laws. In 2014, New York-Presbyterian Hospital and Columbia University Medical Center were fined $4.8 million in HIPAA violations when PHI records were accidentally exposed (Friedman, 2014). From 2014 to 2015, Anthem Inc, a health insurer, suffered a series of cyberattacks that exposed the electronic health information of nearly 80 million patients. As a result, Anthem was fined $16 million for HIPAA violations that did not include a $115 million settlement from class-action lawsuits (Commins, 2018; Drees, 2020). In June 2018, MD Anderson was fined $4.3 million in HIPAA violations for losing more than 35,000 patients' PHI records (Drees, 2021). In 2020, the Swedish data protection authority fined Capio St. GOran's Hospital $3.4 million due to GDPR violations for insufficient measures in protecting patients' records (Tessian, 2021; DataGuidance, 2020) (for more information on other related governmental legislation, see Appendix E).

With the aforementioned types of losses from a cyberattack, we consider four component cost distributions C₁ᵢ, C₂ᵢ, C₃ᵢ, and C₄ᵢ, which were either fitted or assumed log-normal distributions (see Appendix F), that sum the total cost Cᵢ for the component in group i. These costs materialize when a component is compromised. In this work, we consider a worst-case scenario by defining C₁ᵢ as the cost of total replacement of the component. However, one may be interested in using a maintenance cost distribution instead of the data available. For each component, there is a loss of revenue due to the cost per hour of downtime for the component not operating as defined by C₂ᵢ. A cost due to data breach based on the number of PHI records compromised as well as a diminished productivity cost of per hour increased time it takes for medical personnel to complete their routine tasks is defined by C₃ᵢ and C₄ᵢ, respectively. These four component cost distributions constitute the total cost distribution for a component in group i defined as

Cᵢ:=C₁ᵢ+C₂ᵢ+C₃ᵢ+C₄ᵢ.

The publicly available data for the U.S. suggests that the cost distribution of the different medical components of the hospital is given in Table 2 (sources listed in the table).

To illustrate and visualize our analytical results for the loss distribution, we now focus on the numerical implications.

### Numerical Implications

In this section, we demonstrate various implications of the analytical results by investigating the effects of a hospital's and its components' cybersecurity protection on the expectation and deviation of loss. Next, we investigate the effects of the number of patient rooms utilized during a cyberattack on the loss distribution for different cybersecurity protection of a hospital. Finally, we investigate a hospital's loss due to business interruption from a cyberattack.

The frequency and source of the cyberattacks as well as the cyber vulnerabilities of a hospital vary vastly across hospitals because each hospital contracts with different vendors for their medical devices, including different models from manufacturers. As an illustrated example of a cyberattack on a hospital and without loss of generality, we assume the stylized parameters to be
the frequency of the cyberattacks is λ=1,
the attack is equally likely to start from each group: a₁=a₂= . . . =a₇=1/7, and
the cyber vulnerabilities are heterogeneous in that pᵢ=p and qᵢ=q ranging from zero to one, which is the lowest to highest usage of cyber protection, respectively.

It is noted that cost for compromised records depends on the network topology distribution of patient rooms per CNS. The values shown here for the records use the network topology described in Table 1 for Scenarios I and II for case 1. In addition, cybersecurity professionals may use the CVEs and corresponding CVSS exploitability scores for the cyber vulnerabilities of a particular hospital. A hospital management team and an insurer may use historical data for the frequency of the cyberattacks and the probability of the origin of the cyberattack starting from each group.

TABLE 2
The expectation and deviation of cost distribution for a single unit of each component
for one-hour loss of revenue and diminished productivity (sources listed in the table).

| | Replacement | | | Revenue | | |
|---|---|---|---|---|---|---|
| Component | E(C₁ᵢ) | \sqrt{Var(C₁ᵢ)} | Source(s) | E(C₂ᵢ) | \sqrt{Var(C₂ᵢ)} | Source(s) |
| HIS | 42,500.00 | 27,500.00 | Escobar (2021); The Office | 576,250.83 | 280,423.38 | Ponemon Institute |
| | | | of the National | | | (2013); Summit- |
| | | | Coordinator for | | | Healthcare (2021) |
| | | | Health Information | | | |
| | | | Technology (2014) | | | |
| PACS | 52,500.00 | 47500 | Trachtman (2018); | 41,684.75 | 42,190.07 | Henson (2019) |
| | | | PostDICOM (2021) | | | |
| DW | 11,000.00 | 6,000.00 | Monitors (2021) | 5,360.97 | 252.84 | Forsberg et al. |
| | | | | | | (2017); Missouri |
| | | | | | | Department of Social |
| | | | | | | Services (2018 |
| IMW | 1,566,666.67 | 799,722.17 | Becker's Hospital | 191.53 | 252.51 | Missouri Department |
| | | | Review (2012); | | | of Social Services |
| | | | Diagnostic and Interventional | | | (2018 |
| | | | Cardiology (2012) | | | |
| | | | Raleigh Radiology (2020); | | | |
| | | | Becker's | | | |
| | | | Hospital Review (2011) | | | |
| CNS | 14,356.25 | 15,011.07 | CeviMed: Medical | 110.92 | 17.27 | Agency for Healthcare |
| | | | Equipment and | | | Research and |
| | | | Supplies (2021); Medical | | | Quality (2021) |
| | | | Device Depot | | | |
| | | | (2021) | | | |
| | | | Acumen Research and | | | |
| | | | Consulting (2020) | | | |
| PM | 7,296.96 | 6,740.39 | SOMA Technology, | 10.92 | 17.27 | Agency for Healthcare |
| | | | INC. (2012); D.R.E. | | | Research and |
| | | | Medical Group, Inc. | | | Quality (2021) |
| | | | (2011); Welch Allyn | | | |
| | | | (2004) | | | |
| | | | Saint Mary's | | | |
| | | | Hospital (2004); Yale-New | | | |
| | | | Haven Hospital (2004) | | | |
| IP | 3,182.63 | 2,161.21 | Laskaris (2015) | 110.92 | 17.27 | Agency for Healthcare |
| | | | | | | Research and |
| | | | | | | Quality (2021) |

| | Replacement | | | Revenue | | |
|---|---|---|---|---|---|---|
| Component | E(C₃ᵢ) | \sqrt{Var(C₄ᵢ)} | Source(s) | E(C₄ᵢ) | \sqrt{Var(C₄ᵢ)} | Source(s) |
| HIS | 3,916,106.85 | 10,690.06 | Seh et al. (2020); American Hospital | 106.46 | 0 | Dempsey and Reilly (2016) |
| | | | Directory (2021) | | | |
| PACS | 889,774.97 | 2,429.46 | Seh et al. (2020); Organisation for | 16,257.05 | 26,347.69 | Mossa-Basha et al. (2020) |
| | | | Economic Co-operation and Development | | | |
| | | | (OECD) (2020a, c) | | | |
| | | | American Hospital Directory (2021) | | | |
| DW | 429 | 63.7 | Seh et al. (2020) | 2,090.77 | 157.89 | Mossa-Basha et al. (2020) |
| IMW | 429 | 63.7 | Seh et al. (2020) | 74.69 | 157.69 | Mossa-Basha et al. (2020) |
| CNS | 8,704.41 | 64.08 | Seh et al. (2020) | 13 | 0 | Dempsey and Reilly (2016) |
| PM | 429 | 63.7 | Seh et al. (2020) | 13 | 0 | Dempsey and Reilly (2016) |
| IP | 429 | 63.7 | Seh et al. (2020) | 13 | 0 | Dempsey and Reilly (2016) |

Total Cost

| Component | E(C₁ᵢ) | \sqrt{Var(C₁ᵢ)} |
|---|---|---|
| HIS | 4,534, 964.14 | 281,971.27 |
| PACS | 1,000, 216.77 | 68,821.18 |
| DW | 18, 880.74 | 6,007.74 |
| IMW | 1,567, 361.89 | 799,722.23 |
| CNS | 23,184.58 | 15,011.22 |
| PM | 7,746.88 | 6,740.71 |
| IP | 3,735.55 | 2,162.22 |

Due to the confidentiality of the contracts with medical device distributors and the aforementioned potential differences between hospitals, we assume, without loss of generality,
the total costs Cᵢ for i=1,2, . . . , 7 of all the medical components within the prototypical hospital are independent and identically distributed (see Table 2).

Hospitals vary in size and number of medical devices. In keeping with the generality of an illustrated example of a hospital, the informed parameters of the size of a prototypical hospital are
the expected number of components in each group being μ₁=8.71, μ₂=12.89, μ₅=8.19, and μ=20.29 (see Table 1).

When it comes to a prototypical hospital, we follow the literature.

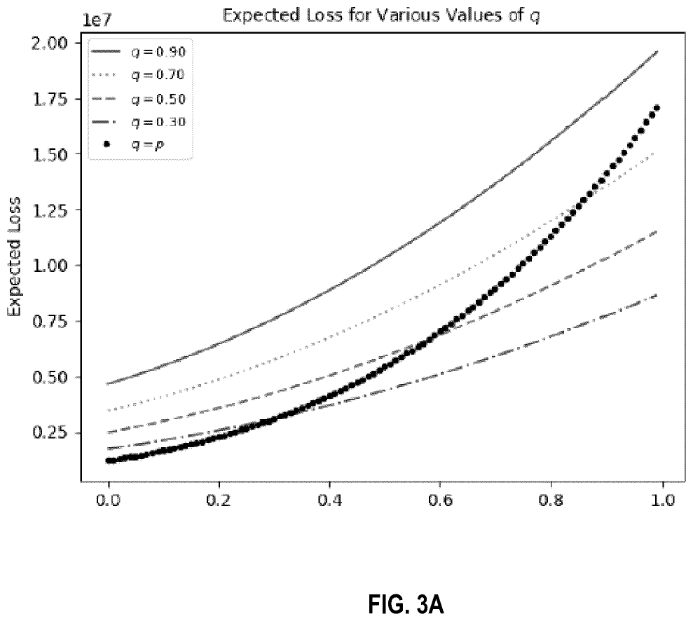

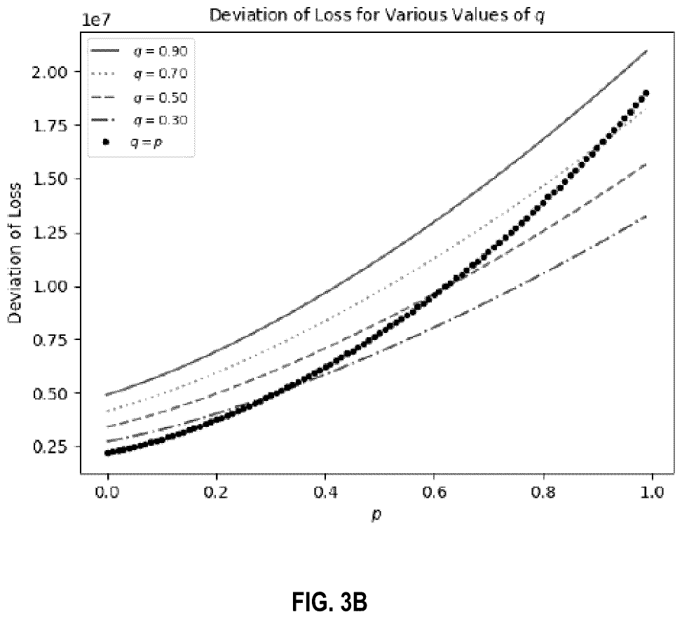

Implication 1. Under these assumed parameter settings along with equations (3) and (4) and Tables 4-11 (see Appendices C and D), the mean and variance of the aggregate loss for t=1 as a function of the parameter p for various values of the parameter q can be visualized in FIGS. 3A-3B to better understand how the cybersecurity protection of a hospital may affect the loss as well as the effects of the bidirectionality of the model.

As expected, the loss is nondecreasing with respect to p and q since lowering the hospital's cybersecurity protection i.e., increasing p or q would yield greater losses. We further investigate how cybersecurity protection of different medical components may compromise the cybersecurity profile of the hospital.

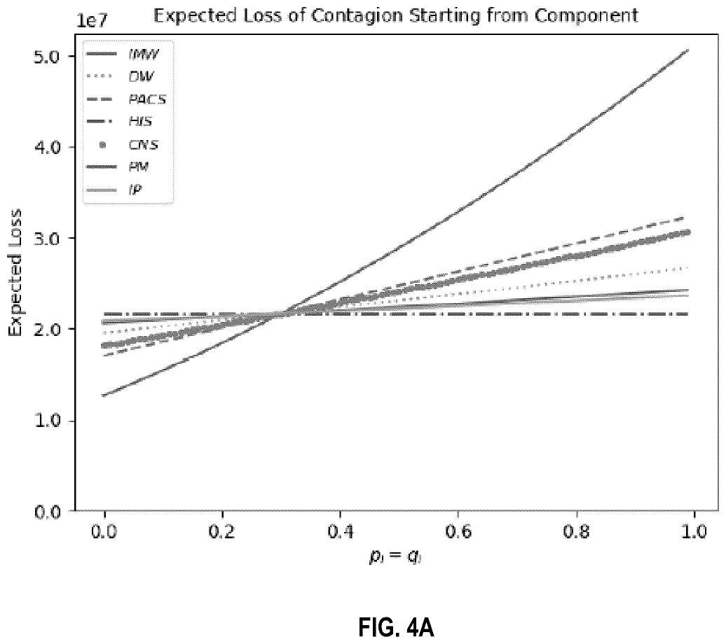

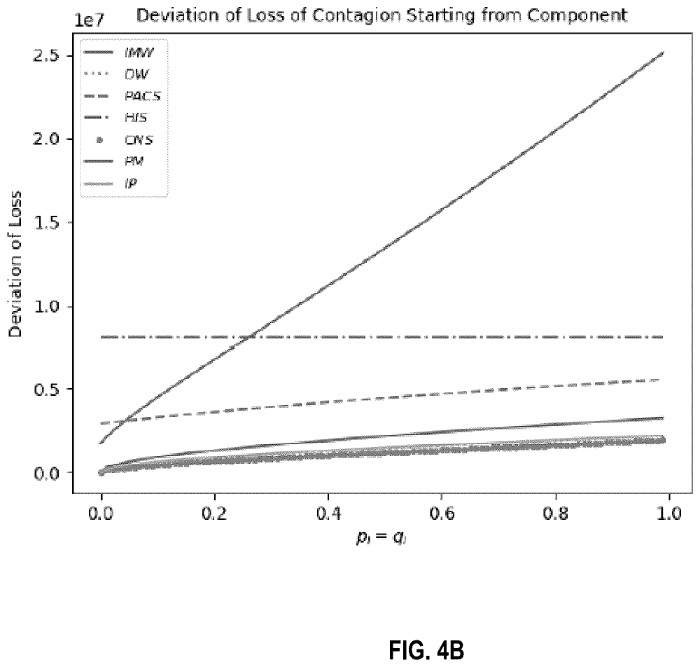

Implication 2. Typically, once a contagion infects one component of the network, the other connected components may be compromised (Kunreuther and Heal, 2003). And so, the integration of new endpoint devices such as medical components with outdated, legacy, or unsupported operating systems increases the cyber risk of healthcare networks (He et al., 2021; Kruse et al., 2017a; Coventry and Branley, 2018; O'Brien et al., 2018). To account for this, we investigate how a compromised medical component due to low cybersecurity protection can jeopardize the overall cybersecurity profile of the hospital. Furthermore in this implication, we no longer assume that the attack is equally likely to start from each group, but rather the attack starts from a particular group of low-protected medical components as shown in FIGS. 4A-4B.

Specifically, FIGS. 4A-4B present many insightful and useful findings for healthcare management and cyber-security teams. First, when a component, whose connections are more secure than the rest of the hospital, is compromised, the contagion starting at the HIS yields the highest financial loss while the contagion starting at the IMWs yields the lowest. However, as a compromised component's connections become less secure than the rest of the hospital, the attack originating from the IMWs yields the highest financial loss. Therefore, the system security of certain components and their network security to the rest of the hospital network are key factors for the scale of the losses and thus pivotal for cybersecurity investment decisions. Second, when a compromised component's connections are the same as the hospital's cybersecurity profile, there is minimal difference in the mean losses for where the contagion starts. However, the deviation of the losses for the HIS and IMWs has a larger dispersion around the mean compared to the other components. This indicates that the loss amounts for these particular components have a larger spread and so the loss distribution may exhibit a long tail, which seems to be the case for cyber risk (see Eling et al. (2022b)). Thus, an attack on certain medical components, depending on the cybersecurity of their connections to the hospital, can result in significantly higher losses and thus jeopardize the overall cybersecurity profile of the hospital. And so, more cybersecurity protection investments, such as continuous patching and updates, in protecting the HIS and IMWs as well as investments, such as firewalls, in their connections to the hospital network may mitigate the scale of the losses. With this in mind, we further investigate how the size of the network may impact the loss distribution.

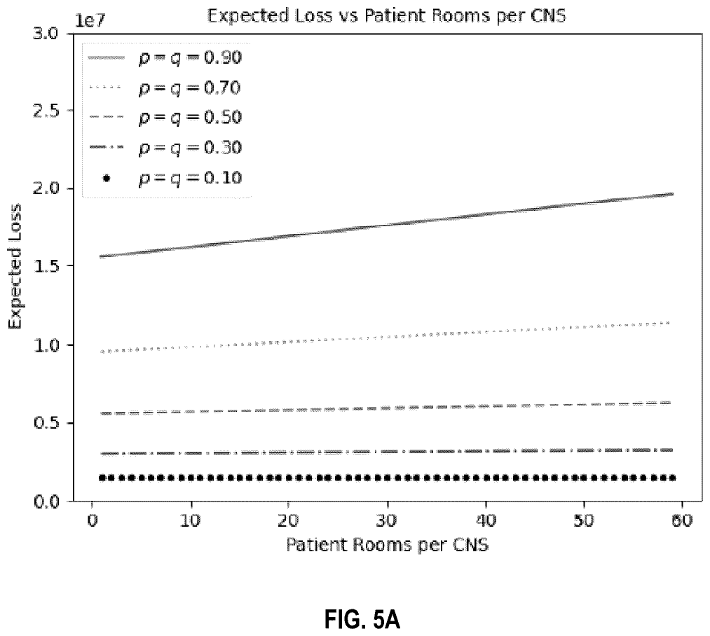

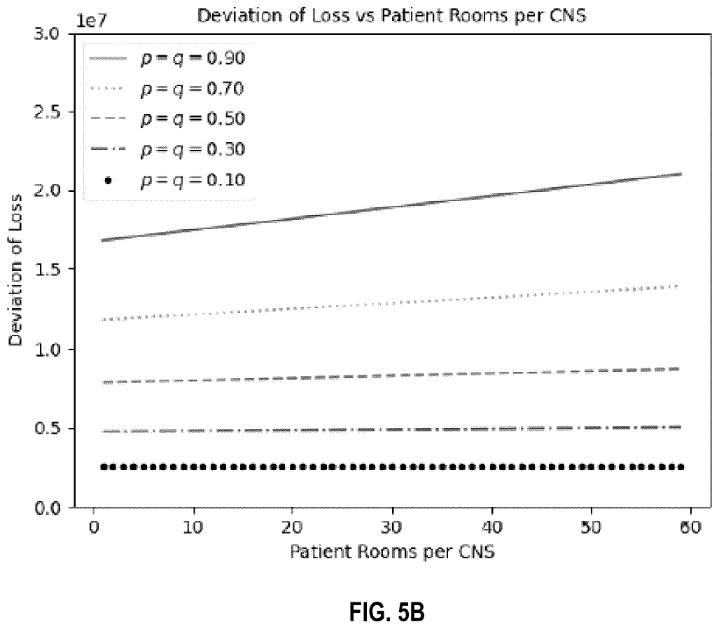

Implication 3. Due to the recent research on how cyberattacks can negatively affect patients' health with the increasing utilization of patient rooms (Mitchell, 2021b; Wetsman, 2021b; Cybersecurity and Infrastructure Security Agency (CISA), 2021) as well as the consideration of medical equipment maintenance (Shamayleh et al., 2020; Mwanza and Mbohwa, 2015) during a cyber-attack, we investigate how a hospital's use or lack thereof cybersecurity protection may affect the loss as a function of patient room utilization per CNS shown in FIGS. 5A-5B.

Not surprisingly, the loss is nondecreasing as more patient rooms are utilized. The figures also demonstrate the loss increases for lower cybersecurity protection, such as the lack of firewalls, in the hospital network. Since cyberattacks have causal damages to medical equipment and hospital performance due to downtime, we continue our investigation into how the losses evolve over a period of time.

Implication 4. Since each medical device may have different cyber vulnerabilities even within the same hospital and considering the bidirectionality of the model, we investigate within this implication two distinct scenarios for the hospital under the consideration that not all pᵢ=p and qᵢ=q.

Scenario I. The first scenario considers a hospital with low cyber protection by having little to no cybersecurity protection especially for, but not limited to, the connections between the PACS and HIS systems since these systems appear to be the most prone to cyberattacks. In this scenario, multiple settings for the high probability of edge contagion are characterized, for simplicity pᵢ=qᵢ, for each component edge. Thus having

p_{IMW}=q_{IMW}=0.60, p_{DW}=q_{DW}=0.80,

p_{PM}=q_{PM}=0.75, p_{IP}=q_{IP}=0.70

and varying values for the edges between the PACS and HIS system by setting

p_{PACS}=q_{PACS} ∈ {0.90, 0.85, 0.80, 0.75, 0.70, 0.65}.

and between the HIS system and CNS by having

p_{CNS}=q_{CNS} ∈ {0.85, 0.80, 0.75, 0.70, 0.65, 0.60}.

Scenario II. The second scenario is a hospital with high cyber protection by keeping devices updated with the most recent patches, using authentication credentials, removing default passwords, and implementing any other cybersecurity protection methods (Eichelberg et al., 2021). Multiple settings for the low probability of edge contagion are characterized by pᵢ=qᵢ for each component in the following

p_{IMW}=q_{IMW}=0.10, p_{DW}=q_{DW}=0.15,

p_{PM}=q_{PM}=0.20, p_{IP}=q_{IP}=0.25

and varying values for the edges between the PACS and HIS system by having

p_{PACS}=q_{PACS} ∈ {0.40, 0.35, 0.30, 0.25, 0.20, 0.15}

and between the HIS system and CNS by letting

p_{CNS}=q_{CNS} ∈ {0.35, 0.30, 0.25, 0.20, 0.15, 0.10 }

Within this implication, we also consider the number of patient rooms in use during a cyberattack as performed in implication 2 and the duration of business interruption. Since hospitals vary in size and the number of patient rooms in use may vary at any given time, we investigate three cases of low, medium, and high patient room utilization.
Case 1 is high patient room utilization by arbitrarily increasing the expected number of patient rooms per CNS from 20.29, provided by Table 1, to 30.
Case 2 considers a medium patient room utilization by using the expected number of patient rooms per CNS of 20.29 provided by Table 1.
Case 3 considers low utilization of patient rooms for each CNS by arbitrarily decreasing the expected number of patient rooms per CNS from 20.29, provided by Table 1, to 10.

We also consider the loss due to business interruption by varying the continuous loss of revenue for each hour of downtime and per hour of diminished productivity. By scaling C₂ᵢ , which is the loss of revenue per hour of downtime, and C₄ᵢ, which is the loss due to diminished productivity of medical personnel, one achieves a better understanding of the total financial loss from a cyberattack. Within this implication, we investigate how the aforementioned scenarios and cases along with the duration of business interruption may affect the scale of the losses.

There are several findings that can be derived from the numerical results presented in Table 3. First, for the different cyber protection measures in a hospital as described by Scenarios I and II with corresponding cases and within each hour of continuous loss, the less cyber-protected hospital yields a higher loss, which corroborates with FIGS. 3A-3B, as demonstrated by the increasing gradient along with the columns. Conversely, the higher cyber-protected hospital yields a lower loss in comparison for all cases and hours of continuous loss. Second, the longer it takes to remediate a cyberattack, especially due to downtime, the larger the expectation and deviation of losses, which is demonstrated by the increasing gradient across the rows. Third, the increase in the utilization of patient rooms during a cyberattack yields a higher expectation and deviation of loss as shown by the increasing gradient along with the columns, which is corroborated by FIGS. 5A-5B. Incorporating the different cyber vulnerabilities for each medical component, we see that the results of these scenarios and cases under the more realistic assumption that not all pᵢ=p and qᵢ=q support the general trends of our model for when pᵢ=p and qᵢ=q. These implications demonstrate the importance of cybersecurity protection within hospital infrastructure and the lack of them can yield considerable loss, especially the longer it takes to remediate the attack. Furthermore, with the loss distribution for the purpose of pricing, an insurer can employ known actuarial pricing techniques such as the actuarial fair premium, standard deviation, expectation principles, etc. (Embrechts, 2000; Kaas et al., 2008).

TABLE 3
Expectation and deviation of continuous loss at various hours for Scenarios I and II based on network topology from Table
1 and cost distributions from Table 2 with increasing color gradient for greater loss. The t = 1 and λ = 1 are assumed.

| | | | | 1 hr | | 12 hrs | |
|---|---|---|---|---|---|---|---|
| Scenarios | Cases | Edge Contagion | Probabilities | E(Lₜ) | \sqrt{Var(Lₜ)} | E(Lₜ) | \sqrt{Var(Lₜ)} |
| Scenario I | Case 1 | PPACS = 0.90 | PCNS = 0.85 | 11,937,771.10 | 13,789,768.29 | 21,863,010.48 | 25,402,147.99 |
| | Case 2 | PPACS = 0.85 | PCNS = 0.80 | 11,295,781.86 | 13,276,034.45 | 20,729,436.55 | 24,505,914.31 |
| | Case 3 | PPACS = 0.80 | PCNS = 0.75 | 10,677,528.20 | 12,768,882.10 | 19,632,660.61 | 23,616,043.71 |
| | | PPACS = 0.75 | PCNS = 0.70 | 10,083,010.12 | 12,268,648.56 | 18,572,682.67 | 22,732,773.81 |
| | | PPACS = 0.70 | PCNS = 0.65 | 9,512,227.62 | 11,775,716.67 | 17,549,502.71 | 21,856,374.82 |
| | | PPACS = 0.65 | PCNS = 0.60 | 8,965,180.70 | 11,290,522.44 | 16,563,120.75 | 20,987,155.53 |
| | | PPACS = 0.90 | PCNS = 0.85 | 11,477,160.93 | 13,281,074.06 | 21,300,441.24 | 24,781,289.32 |
| | | PPACS = 0.85 | PCNS = 0.80 | 10,878,953.72 | 12,812,079.57 | 20,220,340.78 | 23,938,673.61 |
| | | PPACS = 0.80 | PCNS = 0.75 | 10,302,173.04 | 12,348,268.60 | 19,174,218.12 | 23.100,742.31 |
| | | PPACS = 0.75 | PCNS = 0.70 | 9,746,818.88 | 11,889,928.12 | 18,162,073.29 | 22,267,683.01 |
| | | PPACS = 0.70 | PCNS = 0.65 | 9,212,891.25 | 11,437,383.54 | 17,183,906.26 | 21,439,709.24 |
| | | PPACS = 0.65 | PCNS = 0.60 | 8,700,390.14 | 10,991,004.99 | 16,239,712.06 | 20,617,065.17 |
| | | PPACS = 0.90 | PCNS = 0.85 | 10,989,088.92 | 12,744,295.38 | 20,704,331.29 | 24,125,184.37 |
| | | PPACS = 0.85 | PCNS = 0.80 | 10,437,274.05 | 12,323,062.31 | 19,680,89241 | 23,339,607.86 |
| | | PPACS = 0.80 | PCNS = 0.75 | 9,904,438.98 | 11,905,445.92 | 18,680,443.02 | 22,556,877.71 |
| | | PPACS = 0.75 | PCNS = 0.70 | 9,390,583.71 | 11,491,681.92 | 17,726,983.13 | 21,777,130.85 |
| | | PPACS = 0.70 | PCNS = 0.65 | 8,895,708.25 | 11,082,037.35 | 16,796,512.74 | 21,000,523.27 |
| | | PPACS = 0.65 | PCNS = 0.60 | 8,419,812.60 | 10,676,815.68 | 15,897,031.84 | 20,227,233.54 |
| SCENARIO II | Case 1 | PPACS = 0.40 | PCNS = 0.35 | 2,257,229.80 | 3,625,040.76 | 5,070,366.55 | 8,659,950.13 |
| | Case 2 | PPACS = 0.35 | PCNS = 0.30 | 2,120,245.26 | 3,448,999.92 | 4,757,805.60 | 8,253,945.66 |
| | Case 3 | PPACS = 0.30 | PCNS = 0.25 | 1,987,144.51 | 3,271,911.41 | 4,453,031.25 | 7,843,144.56 |
| | | PPACS = 0.25 | PCNS = 0.20 | 1,857,927.54 | 3,093,491.86 | 4,156,043.52 | 7,426,636.59 |
| | | PPACS = 0.20 | PCNS = 0.15 | 1,732,594.35 | 2,913,386.93 | 3,866,842.40 | 7,003,282.40 |
| | | PPACS = 0.15 | PCNS = 0.10 | 1,611,144.95 | 2,731,146.05 | 3,585,427.89 | 6,571,629.84 |
| | | PPACS = 0.40 | PCNS = 0.35 | 2,228,639.72 | 3,582,500.67 | 5,035,795.74 | 8,609,710.98 |
| | | PPACS = 0.35 | PCNS = 0.30 | 2,096,158.05 | 3,413,824.05 | 4,728,679.60 | 8,212,408.11 |
| | | PPACS = 0.30 | PCNS = 0.25 | 1,967,139.78 | 3,243,709.65 | 4,428,841.75 | 7,809,846.14 |
| | | PPACS = 0.25 | PCNS = 0.20 | 1,841,584.90 | 3,071,850.34 | 4,136,282.18 | 7,401,089.57 |
| | | PPACS = 0.20 | PCNS = 0.15 | 1,719,493.41 | 2,897,863.35 | 3,851,000.89 | 6,984,968.94 |
| | | PPACS = 0.15 | PCNS = 0.10 | 1,600,865.33 | 2,721,263.56 | 3,572,997.89 | 6,559,995.73 |
| | | PPACS = 0.40 | PCNS = 0.35 | 2,198,345.09 | 3,537,772.21 | 4,999,163.80 | 8,556,689.97 |
| | | PPACS = 0.35 | PCNS = 0.30 | 2,070,634.74 | 3,376,856.46 | 4,697,817.10 | 8,168,579.88 |
| | | PPACS = 0.30 | PCNS = 0.25 | 1,945,942.35 | 3,214,088.67 | 4,403,210.05 | 7,774,720.76 |
| | | PPACS = 0.25 | PCNS = 0.20 | 1,824,267.90 | 3,049,137.52 | 4,115,342.65 | 7,374,150.85 |
| | | PPACS = 0.20 | PCNS = 0.15 | 1,705,611.39 | 2,881,591.34 | 3,834,214.90 | 6,965,669.53 |
| | | PPACS = 0.15 | PCNS = 0.10 | 1,589,972.83 | 2,710,929.95 | 3,559,826.80 | 6,547,750.54 |

| | | | | 24 hrs | | 48 hrs |
|---|---|---|---|---|---|---|
| Scenarios | Cases | Edge Contagion | Probabilities | E(Lₜ) | \sqrt{Var(Lₜ)} | E(Lₜ) |
| Scenario I | Case 1 | PPACS = 0.90 | PCNS = 0.85 | 40.516.752.95 | 48,508,612.04 | 102,323,673.50 |
| | Case 2 | PPACS = 0.85 | PCNS = 0.80 | 38,457,869.20 | 46,899,800.48 | 97,196,319.52 |
| | Case 3 | PPACS = 0.80 | PCNS = 0.75 | 36,468,487.12 | 45,304,277.57 | 92,261,642 80 |
| | | PPACS = 0.75 | PCNS = 0.70 | 34,548,606.71 | 43,722,866 29 | 87,519.643.59 |
| | | PPACS = 0.70 | PCNS = 0.65 | 32,698,227.96 | 42,156,499.47 | 82,970,321.63 |
| | | PPACS = 0.65 | PCNS = 0.60 | 30,917,350.88 | 40,606,237.83 | 78,613,677.02 |
| | | PPACS = 0.90 | PCNS = 0.85 | 39,842,955.63 | 47,780,853.10 | 101,427,420.00 |
| | | PPACS = 0.85 | PCNS = 0.80 | 37,848,117.82 | 46,244,251.95 | 96,385,256.92 |
| | | PPACS = 0.80 | PCNS = 0.75 | 35,919,403.92 | 44,710,778.91 | 91,531,278.24 |
| | | PPACS = 0.75 | PCNS = 0.70 | 34,056,813.91 | 43,189,192.70 | 86,065,481.95 |
| | | PPACS = 0.70 | PCNS = 0.65 | 32,260,347.80 | 41,680,353.07 | 82,387,874.05 |
| | | PPACS = 0.65 | PCNS = 0.60 | 30,530,005.59 | 40,185,237.32 | 78,098,448.55 |
| | | PPACS = 0.90 | PCNS = 0.85 | 39,128,986.10 | 47,028,282.86 | 100,477,731.34 |
| | | PPACS = 0.85 | PCNS = 0.80 | 37,202,012.70 | 45,551,837.25 | 95,525,838.29 |
| | | PPACS = 0.80 | PCNS = 0.75 | 35,337,584.04 | 44,084,180.93 | 90,757,368.82 |
| | | PPACS = 0.75 | PCNS = 0.70 | 33,535,700.13 | 42,626,007.11 | 86,172,322.92 |
| | | PPACS = 0.70 | PCNS = 0.65 | 31,796,360.97 | 41,178,100.96 | 81,770,700.59 |
| | | PPACS = 0.65 | PCNS = 0.60 | 30,119,566.55 | 39,741,354.49 | 77,552,501.85 |
| SCENARIO II | Case 1 | PPACS = 0.40 | PCNS = 0.35 | 9,710,590.50 | 17,982,745.82 | 23,910,039.30 |
| | Case 2 | PPACS = 0.35 | PCNS = 0.30 | 9,125,595.31 | 17,189,267.62 | 22,526,934.90 |
| | Case 3 | PPACS = 0.30 | PCNS = 0.25 | 8,558,465.67 | 16,394,475.83 | 21,200,077.24 |
| | | PPACS = 0.25 | PCNS = 0.20 | 8,009,201.60 | 15,598,011.84 | 19,929,466.34 |
| | | PPACS = 0.20 | PCNS = 0.15 | 7,477,803.10 | 14,799,439.33 | 18,715,102.19 |
| | | PPACS = 0.15 | PCNS = 0.10 | 6,964,270.16 | 13,998,221.60 | 17,556,984.78 |
| | | PPACS = 0.40 | PCNS = 0.35 | 9,669.495.26 | 17,930,026.73 | 23,855,895.19 |
| | | PPACS = 0.35 | PCNS = 0.30 | 9,090,972.46 | 17,146,131.64 | 22,481.318.34 |
| | | PPACS = 0.30 | PCNS = 0.25 | 8,529,710.96 | 16,360,318.95 | 21,162,192.12 |
| | | PPACS = 0.25 | PCNS = 0.20 | 7,985,710.76 | 15,572,189.73 | 19,898,516.52 |
| | | PPACS = 0.20 | PCNS = 0.15 | 7,458,971.87 | 14,781,259.01 | 18,690,291.53 |
| | | PPACS = 0.15 | PCNS = 0.10 | 6,949,494.28 | 13,986.930.61 | 17,537,517.16 |
| | | PPACS = 0.40 | PCNS = 0.35 | 9,625,949.89 | 17,874,351.36 | 23,798,522.97 |
| | | PPACS = 0.35 | PCNS = 0.30 | 9,054,265.38 | 17,100,581 66 | 22,432,982.11 |
| | | PPACS = 0.30 | PCNS = 0.25 | 8,499,241.88 | 16,324,255.43 | 21,122,048.27 |
| | | PPACS = 0.25 | PCNS = 0.20 | 7,960,819.39 | 15,544,931.58 | 19,865,721.44 |
| | | PPACS = 0.20 | PCNS = 0.15 | 7,439,017.91 | 14,762,074.26 | 18,664,001.64 |
| | | PPACS = 0.15 | PCNS = 0.10 | 6,933,837.46 | 13,975,025.09 | 17,516,888.86 |

| Sce- | | | | | | |
|---|---|---|---|---|---|---|
| nar- | | Edge | | 48 hrs | 72 hrs | |
| ios | Cases | Contagion | Probabilities | \sqrt{Var(Lₜ)} | E(Lₜ) | \sqrt{Var(Lₜ)} |
| Sce- | Case | PPACS = 0.90 | PCNS = 0.85 | 129,103,388.82 | 196,796,508.18 | 255,885,026.67 |
| nar- | 1 | PPACS = 0.85 | PCNS = 0.80 | 125,168,129.46 | 186,976,883.18 | 248,449,180.37 |
| io | Case | PPACS = 0.80 | PCNS = 0.75 | 121,281,745.54 | 177,550,135.63 | 241,125,204.55 |
| I | 2 | PPACS = 0.75 | PCNS = 0.70 | 117,448,181.64 | 168,516,265.53 | 233,922,429.51 |
| | Case | PPACS = 0.70 | PCNS = 0.65 | 113,671,844.37 | 159,875,272.87 | 226,851,185.82 |
| | 3 | PPACS = 0.65 | PCNS = 0.60 | 109,957,660.78 | 151,627,157.66 | 219,922,908.60 |
| | | PPACS = 0.90 | PCNS = 0.85 | 128,199,690.54 | 195,677,798.52 | 254,793,762.35 |
| | | PPACS = 0.85 | PCNS = 0.80 | 124,349,642.96 | 185,964,509.37 | 247,464,027.67 |
| | | PPACS = 0.80 | PCNS = 0.75 | 120,545,250.68 | 176,638,489.55 | 240,241,899.97 |
| | | PPACS = 0.75 | PCNS = 0.70 | 116,790,367.24 | 167,699,739.04 | 233,136,577.33 |
| | | PPACS = 0.70 | PCNS = 0.65 | 113,089,287.11 | 159,148,257.86 | 226,158,241.87 |
| | | PPACS = 0.65 | PCNS = 0.60 | 109,446,810.36 | 150,984,046.00 | 219,318,162.37 |
| | | PPACS = 0.90 | PCNS = 0.85 | 127,244,353.01 | 194,492,390.72 | 253,639,521.56 |
| | | PPACS = 0.85 | PCNS = 0.80 | 123,484,597.42 | 184,891,777.23 | 246,422,209.56 |
| | | PPACS = 0.80 | PCNS = 0.75 | 119,767,063.57 | 175,672,490.58 | 239,307,955.01 |
| | | PPACS = 0.75 | PCNS = 0.70 | 116,095,494.77 | 166.834,530.77 | 232,305,818.59 |
| | | PPACS = 0.70 | PCNS = 0.65 | 112,474,069.70 | 158,377,897.79 | 225,425.828.13 |
| | | PPACS = 0.65 | PCNS = 0.60 | 108,907,457.27 | 150,302,591.64 | 218,679,079.47 |
| SCE- | Case | PPACS = 0.40 | PCNS = 0.35 | 50,890,660.37 | 44,668,155.94 | 103,561,730.74 |
| NAR- | 1 | PPACS = 0.35 | PCNS = 0.30 | 48,926,365.39 | 42,149,288.05 | 99,892,885.12 |
| IO | Case | PPACS = 0.30 | PCNS = 0.25 | 46,992,772.66 | 39,749,345.79 | 96,315,070.55 |
| II | 2 | PPACS = 0.25 | PCNS = 0.20 | 45,093,597.02 | 37,468,329.18 | 92,837,951.87 |
| | Case | PPACS = 0.20 | PCNS = 0.15 | 43,233,129.43 | 35,306,23820 | 89,472,955.77 |
| | 3 | PPACS = 0.15 | PCNS = 0.10 | 41,416,330.92 | 33,263,072.87 | 86,232,083.39 |
| | | PPACS = 0.40 | PCNS = 0.35 | 50,834,990.05 | 44,600,962.96 | 103,501,127.99 |
| | | PPACS = 0.35 | PCNS = 0.30 | 48,881,687.10 | 42,092,677.79 | 99,845,255.32 |
| | | PPACS = 0.30 | PCNS = 0.25 | 46,958,190.17 | 39,702,330.26 | 96,278,749.39 |
| | | PPACS = 0.25 | PCNS = 0.20 | 45,068,152.66 | 37,429,920.37 | 92,811,702.56 |
| | | PPACS = 0.20 | PCNS = 0.15 | 43,215,794.75 | 35,275,448.11 | 89,455,461.37 |
| | | PPACS = 0.15 | PCNS = 0.10 | 41,405,996.18 | 33,238,913.50 | 86,227,739.49 |
| | | PPACS = 0.40 | PCNS = 0.35 | 50,776,148.17 | 44,529,763.90 | 103,437,564.20 |
| | | PPACS = 0.35 | PCNS = 0.30 | 48.834.465.58 | 42,032,692.40 | 99,794.884.25 |
| | | PPACS = 0.30 | PCNS = 0.25 | 46,921,641.24 | 39,652,511.64 | 96,240,339.39 |
| | | PPACS = 0.25 | PCNS = 0.20 | 45,041,263.99 | 37,389,221.60 | 92,783,945.58 |
| | | PPACS = 0.20 | PCNS = 0.15 | 43,197,479.52 | 35,242,822.30 | 89,436,964.81 |
| | | PPACS = 0.15 | PCNS = 0.10 | 41,395,082.03 | 33,213,313.73 | 86,212,018.52 |

### Conclusion

As described, we develop a dynamic structural percolation model for the aggregate loss distribution across multiple attacks for cyber risk on a mixed-random network such as a prototypical hospital. We investigate the documented cyber vulnerabilities of a hospital's internal network and its major medical assets such as CT scanners, patient monitors, and infusion pumps. We impose contagion processes, based on percolation theory, on the hospital's internal network to model a cyberattack. We allow for a stochastic nature of the hospital topology, including a temporal uncertainty of costs for each component such as costs due to downtime, data breach, replacement of the medical device, and diminished productivity of medical personnel. Within a rigorous mathematical framework through probabilistic analysis, we characterize the mean and variance of loss, which are the main aspects of the loss distribution of cyber risk. Characterizing the financial losses of cyber risk can serve as a resource for prioritizing cybersecurity protection investments and actions to mitigate that risk. Therefore, with the constructed mean and variance of loss, healthcare administrators and cybersecurity professionals can quantify a hospital's cyber risk and find insights into better investment strategies for the network security of a hospital. Additionally, with the constructed mean and variance, an insurer can employ known actuarial pricing principles. From this framework, we reduce the complexity of cyber risk within a hospital setting and allow for its effective modeling and loss distribution characterization.

We investigate how different measures of cyber protection in a hospital network can affect the scale of the loss distribution. Since a hospital contracts with different medical device manufacturers, each hospital will have different cybersecurity measures and vulnerabilities. This framework allows for this characteristic by considering different edge probabilities in the hospital network for each group of medical components. Furthermore, this framework gauges the financial impact of the lack of cybersecurity protection for each group of medical components. This helps hospital risk managers, cybersecurity management teams, and actuaries quantify a hospital's cyber vulnerabilities in terms of financial losses and prioritize cyber risk mitigation strategies.

We also investigate how the size of the hospital and the number of patient rooms being utilized during a cyberattack can increase losses. From our findings, the more patients being cared for during a cyberattack or the larger the size of the hospital, the higher the financial losses. Therefore, hospital risk managers and cybersecurity professionals should consider the size of the network for a greater attack surface.

Incorporating the above investigations, we study how business interruption from a cyberattack can increase losses. An important loss consequence of a cyberattack is the loss of revenue due to downtime. By varying the continuous loss of revenue for each hour of downtime and diminished employee productivity, hospital risk managers and cybersecurity management teams can account for the remediation time of an attack as part of their risk characterization. In addition, our findings demonstrate how improved cybersecurity measures can lead to lower financial losses even during a business interruption.

Furthermore, this framework provides hospital risk managers, cybersecurity management teams, and cyber risk actuaries with a tool to model a cyberattack on a hospital's internal network and to yield the associated loss distribution. By using a mixed random graph, the framework can model various sizes of hospital networks. By incorporating different edge probabilities, the framework allows for diverse cybersecurity measures. From the considered cost distributions, an insurer and hospital administrator can better understand the financial losses. Due to the increasing frequency and severity of cyberattacks on hospitals, our work provides value to decision-makers to better understand the potential financial losses from a cyberattack on hospital networks and other mixed random networks. Because cyber risk is an emerging opportunity for insurers, the construction of the loss distribution proposed in this paper can be of considerable value for the purpose of pricing this new type of risk.

Because of the increasing use of technology in healthcare, there are abundant opportunities for further research following this work. One is the incorporation of telemetry radiology and/or remote patient monitoring. Another is the incorporation of other medical devices commonly used in healthcare such as pacemakers or accounting for different models of a medical device. Since the underlying topology is a mixed random graph with bidirectional edges for each group of components, one can apply the structure and the analytical results of the loss distribution to other networks such as those found in the hospitality industry.

### Computing Device

Referring to FIG. 6, a computing device 1200 is illustrated which may be configured, via the application 104 and/or computer-executable instructions, to execute functionality described herein. More particularly, in some embodiments, aspects of the loss model functionality described herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

### APPENDICES

### A. Connectivity

IMW and PACS. The IMWs send the images to be centrally archived in the PACS system (Davis, 2018; Huang, 2009; Mah and Higgins, 2012). Typically, the data flow from the IMW to the PACS system is unidirectional; however, some data flows allow a technologist or radiologist, who may want to reference a recently acquired image, to have it be sent back to the IMW (Mah and Higgins, 2012). The images transferred between an IMW and the PACS system use the Digital Imaging and Communications in Medicine (DICOM) standard, which uses Transport Control Protocol/Internet Protocol (TCP/IP) as its underlying protocol typically via Ethernet since it is one of two popular communication protocols used in medical imaging (Huang, 2009). Part 10 of DICOM is the standard file format for the distribution of medical images and underlying communication protocol (Huang, 2009). The PACS system was developed to assist the transition from analog to digital storage for medical images. PACS systems obtain images from imaging devices such as Ultrasound, CT, and MRI and store the images in the DICOM format (Health Sector Cybersecurity Coordination Center, 2020).

DW and PACS. The PACS system then archives the scans from the IMW in a database and distributes scans to radiologists at the DW (Huang, 2009; Mirsky et al., 2019). The DW returns the diagnosis to the PACS system (Huang, 2009).

PACS and HIS. The PACS forwards the diagnosis to the HIS system as part of the patient's electronic health record (Huang, 2009). The HIS interfaces with the PACS system based on the Health Level 7 (HL7) standard via the TCP/IP over Ethernet on a client-server model (Huang, 2009; Feng, 2020). The HL7 standard is for electronic data exchange in healthcare environments, particularly for hospital applications such as the HIS and PACS systems being able to share information (Huang, 2009). Therefore, the PACS system is connected to the HIS system in a bidirectional manner (Huang, 2009).

HIS and CNS. Nurses stationed at the CNS can update patient information to the HIS system or download patient information from the HIS system (Mehdipour and Zerehkafi, 2013; Poissant et al., 2005). This results in the CNS has a bidirectional connection to the HIS system.

CNS and PM. A CNS acquires data from PMs via connections to patient rooms (Mokarami et al., 2021; Sun et al., 2020) that may have only one PM per patient room (Department of Veterans Affairs, 2011). The PM sends updates and alarms to the CNS (Benyon, 2020) via wireless or wired by the TCP/IP protocol (McKee, 2018; Mah and Higgins, 2012). The PM, which is not connected to other medical devices within the patient room, can connect to the patient room's Wi-Fi access point to send real-time information to the CNS (O'Brien, 2016; Mah and Higgins, 2012; General Electric Company, 2012).

CNS and IP. Similar to the PM, a CNS also acquires data from IPs via the connections to the patient rooms (Mokarami et al., 2021; Sun et al., 2020) and may have only one IP per patient room (Department of Veterans Affairs, 2011). Infusion pumps can connect to the hospital's internal Wi-Fi network such as an access point in the patient room (O'Brien et al., 2018). Once the IP is connected to the access point, it is then connected to the CNS (Mah and Higgins, 2012). Many IPs are equipped with safety features, such as alarms, to alert the nurse at the CNS in the event of a problem (U.S. Food and Drug Administration (FDA), 2018).

### B. Cyber Vulnerabilities

Hospital infrastructure vulnerabilities. A reason hospitals have become a fruitful target for hackers is due to the security vulnerabilities in their IT systems being reliant on aging computer systems that do not use the latest security features (Paul III et al., 2018; Humer and Finkle, 2014). According to a recent report from Palo Alto Networks, a cybersecurity company in California, the general security posture of Internet-of-Things (IoT) devices is declining, leaving organizations vulnerable to new IoT-targeted malware as well as older attack techniques (Palo Alto Networks, 2020). According to this report, 83% of medical imaging devices run on old operating systems, which leaves vulnerabilities to older attacks such as Conficker (Palo Alto Networks, 2020). Because attackers know the vulnerabilities of decades-old standard operational technology protocols such as the DICOM protocol, they can use these vulnerabilities to disrupt hospital operations (Palo Alto Networks, 2020). The biomedical engineers, who maintain medical devices, do not typically maintain the underlying operating systems of medical devices (Palo Alto Networks, 2020). And because of their long lifecycles, these network-connected medical devices such as X-Ray machines often run end-of-life operating systems with known vulnerabilities and pose a high risk to the hospital's employees, patients, computer systems, and eventually business operations (Palo Alto Networks, 2020).

In addition, because of the sudden adaptation of IT and networked medical devices without the increase of dedicated IT support staff for the cybersecurity of these assets, ransomware has made it easy for hackers to attack hospitals (Office of the National Coordinator for Health Information Technology, 2015). This adaptation occurred after the government allocated funds for the Meaningful Use incentive in 2009, which was used to encourage the use of EHR systems (Office of the National Coordinator for Health Information Technology, 2015). With this incentive, EHR system utilization has increased from 9.4% in 2008 to 96.9% in 2014 (Office of the National Coordinator for Health Information Technology, 2015). With such a substantial increase in IT utilization in a short time frame, many healthcare facilities have been unable to adopt adequate networks and other IT resources to combat potential cyberattacks (Verizon, 2016). The design of security features to be incorporated into devices is challenging since access by doctors and medical staff is required for efficient and accurate patient care (Howarth, 2014). Hospitals have not been structured to include software security as part of their operations, so they are not equipped to deal with potential attacks on medical devices (Kumar, 2017). Without adequate resources, many hospitals simply do not have the staff to provide simple barriers to hackers such as prompt installation of patches (Paul III et al., 2018). Therefore in 2016, 85% of successful exploits take advantage of vulnerabilities such as outdated patches (Verizon, 2016). The situation is only made worse since 72% of healthcare internal networks mix loT and IT assets, allowing malware to spread from hospital users' computers to vulnerable medical devices on the same network (Palo Alto Networks, 2020). Thus, it comes as no surprise that there is a 41% rate of attacks exploiting device vulnerabilities are IT-borne attacks scanning for network-connected devices in an attempt to exploit known weaknesses (Palo Alto Networks, 2020). Even with these known vulnerabilities, the connections between a medical device and hospital network are crucial for healthcare providers to “treat patients better by making more well-informed treatment decisions, and avoid wasting time and money” (Kumar, 2017). Even without investigating each medical device's cyber vulnerabilities, the overall network and infrastructure of a hospital-like network are already at serious risk. Vendors and manufacturers of many medical devices require remote access for device repairs, configuration, software, firmware patching, and updates (O'Brien, 2016; General Electric Company, 2012; Forescout Research Labs, 2020). Due to this remote access, these medical devices would be directly or indirectly connected to the internet (Forescout Research Labs, 2020). Depending on the hospital and the vendors, there are various ways medical devices are connected directly or indirectly to the internet, such as in teleradiology (Weisser et al., 2007), but it provides potential exposure to cyberattacks on these medical devices. For each medical device vulnerability, there is an assigned Common Vulnerabilities and Exposures (CVE), which are publicly known information system vulnerabilities stored in the National Vulnerability Database (National Institute of Standards and Technology (NIST), 2021a). For each CVE, there is a corresponding Common Vulnerability Scoring System (CVSS) that is used for calculating the severity of vulnerabilities of a system such as the CVSS base score that ranges from 0 to 10, which is low to critical severity, respectively (National Institute of Standards and Technology (NIST), 2021b). The CVE and its corresponding CVSS base score allow an insurer to know what hospital assets are at risk of being hacked and the potential severity of exploiting their vulnerabilities, especially for the following medical devices.

HIS. In 2018, the HIS system of Hancock Regional Hospital was a victim of a ransomware attack. The cyberattack affected the hospital's email system, electronic health records, and other internal operating systems (Hays, 2018; CBS News, 2018). An EHR system, which is integrated with a HIS system, that has insufficient session expiration contains a vulnerability where an attacker can gain access to PHI records and potentially modify the information according to CVE 2018-5438 with a CVSS base score of 6.3. The vulnerabilities in the Philips Tasy EMR system have the potential of allowing unauthorized PHI records to be extracted according to CVEs 2021-39375 and 2021-39376 with a CVSS base score of 8.8 each.

PACS. The PACS system is very vulnerable to cyber-attacks since it can be intentionally or accidentally exposed to the internet (Mirsky et al., 2019). From a report by Greenbone Networks, a cybersecurity company based in Germany, some PACS systems are accidentally or intentionally exposed to the internet (Greenborne Networks, 2019). The number of accessible medical images without secured protection from exposed PACS systems to the internet globally was 370 million (Greenborne Networks, 2019). This vulnerability left personally identifiable information of more than one million Americans exposed (Warner, 2019). Between July 2019 and December 2020, Sutter Buttes Imaging reported unauthorized access to its PACS system that resulted in the exposure of patient data (Davis, 2021c). Roosevelt General Hospital reported that malware was discovered in its PACS system as of January 2020 (O'Connor, 2020a). Northeast Radiology reported that its PACS system had been hacked, which resulted in exposing patient data in March 2020 (HIPAA Journal, 2019; O'Connor, 2020b). A team of researchers from Ben Gurion University Cyber Security Research Center in Israel demonstrated how an attacker could take advantage of vulnerabilities in a hospital's PACS system and launch malware that could alter authentic CT lung scans (Mirsky et al., 2019; O'Connor, 2019; Butler, 2019).

From the client-server PACS model, the PACS system is a single point of failure; if it goes down, the entire PACS is nonfunctional (Huang, 2009), preventing radiologists from making their diagnoses. The network between PACS and the IMWs have “no security with respect to the PACS infrastructure because any user with a password can have access to the external network and retrieve all information passing through it” (Huang, 2009). Due to the DICOM protocol, which was developed thirty years ago, makes PACS systems easily accessible via the internet (Warner, 2019; Health Sector Cybersecurity Coordination Center, 2021). Vulnerable PACS servers face additional exposure when directly connected to the internet without some type of protection such as a firewall, virtual private network (VPN), or secure password (Health Sector Cybersecurity Coordination Center, 2020, 2021; Forescout Research Labs, 2020). Even if the PACS system is not directly connected to the internet, it is indirectly connected via the hospital's internal network (Mirsky et al., 2019). The lack of cyber protection for PACS systems can range from known default passwords and hardcoded credentials to a lack of authentication within third-party software (Health Sector Cybersecurity Coordination Center, 2020, 2021; Forescout Research Labs, 2020). In 2015, GE Healthcare Centricity PACS 4.0 Server had unsecured default passwords that could be potential attack vectors according to CVE 2012-6693 with a CVSS base score of 10.0. Other similar vulnerabilities for this PACS system are disclosed in CVEs 2012-6694, 2012-6695, and 2013-7442. In 2021, the PacsOne Server was documented to be vulnerable to SQL injections according to CVE 2020-29163 with a CVSS base score of 8.8. Other vulnerabilities for the PacsOne Server are disclosed by CVEs 2020-29164, 2020-29165, and 2020-29166. Since medical imaging digital files use DICOM, the DICOM Part 10 File Format had a vulnerability that can “contain the header for an executable file, such as Portable Executable malware” according to CVE 2019-11687 with a CVSS base score of 7.8. Eichelberg, Kleber, and Kammer (2021) analyzed other specific attacks and threat vectors of the PACS system (Eichelberg et al., 2021). Such threats could allow an attacker to compromise connected clinical devices and laterally spread malicious code to other devices on the network undetected (Health Sector Cybersecurity Coordination Center, 2020, 2021).

IMW. The IMW is also vulnerable to cyberattacks (Mirsky et al., 2019). The hacking group Orangeworm targeted the healthcare sector and infected many computers with the malware Kwampirs, which was found on image modalities such as computers that control X-Ray and MRI machines in 2018 (Davis, 2018; Broadcom, 2018). During that year, the U.S. Department of Homeland Security reported vulnerabilities in the Philips' Brilliance CT scanner system that may allow an attacker to attain higher-level privileges and unauthorized access (Cybersecurity and Infrastructure Security Agency (CISA), 2018). The GE Healthcare Optima CT680, CT540, CT640, and CT520 scanners had unsecured default passwords, which could be a potential attack vector according to CVE 2010 5306 with a CVSS base score of 10.0. The Philips MRI 1.5T and MRI 3T scanners had vulnerabilities that may allow an unauthorized user to modify system configuration or export patient data according to CVEs 2021-26262, 2021-26248, and 2021-42744 with a CVSS base score of 5.5 each as of 2021. Due to the intimate connections in the imaging process, an attacker could comprise an IMW and DW (Mirsky et al., 2019).

DW. The Conficker worm infected DWs that were running an unpatched version of a Microsoft operating system in 2008 (Keen, 2010). The GE Xeleris medical imaging workstations versions 1.0, 1.1, 2.2, 3.0, and 3.1 have severely documented vulnerabilities (Health Sector Cybersecurity Coordination Center, 2021). The GE Xeleris systems had unsecured default or hard-coded credentials that may allow a remote attacker to bypass authentication and gain access to the medical devices according to CVE 2017-14006 with a CVSS base score of 9.8. In 2019, GE Centricity PACS RA1000, which is a specific model of a DW, has the same vulnerabilities and consequences as the GE Xeleris systems according to CVE 2017-14008 with a CVSS base score of 9.8.

CNS. In January 2020, the FDA reported vulnerabilities and enacted a Class II recall of the CARESCAPE Central Station (CSCS) version 1 (U.S. Food and Drug Administration (FDA), 2020). This CNS enabled medical professionals to review patient information but the vulnerabilities could introduce risks to patients while they are being monitored (U.S. Food and Drug Administration (FDA), 2020). The vulnerabilities could allow an attacker to control the CNS and “to silence alarms, generate false alarms and interfere with alarms of patient monitors” (Benyon, 2020; U.S. Food and Drug Administration (FDA), 2020; Cybersecurity and Infrastructure Security Agency (CISA), 2020). Cybersecurity researchers from McAfee have demonstrated that the data flow between a PM, which uses the networking protocol RWHAT for monitoring a patient's vitals, and a CNS can be hacked with the possibility of the information being transmitted could be altered (Sweeney, 2018; Leyden, 2018). The Philips Patient Information Center iX (PICiX) Versions B.02, C.02, and C.03, which are particular models of CNS, had unsecured file permissions that allowed information to be exposed to the wrong party according to CVE 2020-16212 with a CVSS base score of 6.8. Other vulnerabilities for the Philips Patient Information Center iX are disclosed by CVEs 2020-16216, 2020-16224, 2020-16228, 2020-16222, 2020-16214, 2020-16218, and 2020-16220.

PM. In January 2020, a report by CISA described how the GE CARESCAPE B450, B650, and B850 patient monitors were vulnerable to cyberattacks that could allow an attacker to obtain PHI data, make changes to alarm settings, or interfere with the functionality of the device (Cybersecurity and Infrastructure Security Agency (CISA), 2020). The Philips IntelliVue patient monitors MX100, MX400-MX850, and MP2-MP90 Versions N and prior have the same vulnerabilities under the CVEs as those for the Philips Patient Information Center iX.

IP. Infusion pumps can be infected by malware, which can cause a malfunction and pose a potential risk to the patient (O'Brien et al., 2018). In 2017, vulnerabilities were found in the Smiths Medical Medfusion 4000 wireless syringe infusion pumps (Davis, 2017). In 2018 at the RSA Conference, vulnerabilities of IPs were demonstrated (Zaldivar et al., 2020). The IPs could potentially be used as gateways to access a hospital's network (O'Brien, 2016; O'Brien et al., 2018). The IPs, like many other medical devices, do not have antivirus or anti-malware software because the protection could negatively impact the pump's ability to operate effectively (O'Brien et al., 2018). The Smiths Medical Medfusion 4000 Wireless Syringe Infusion Pump Versions 1.1, 1.5, and 1.6 had documented vulnerabilities of a third-party component allowing an attacker to alter the control flow or crash the system according to CVE 2017-12718 with a CVSS base score of 8.1. Other vulnerabilities for the Medical Medfusion 4000 Wireless Syringe Pump are disclosed by CVEs 2017-12725, 2017-12724, 2017-12723, 2017-12722 2017-12721, and 2017-12720. In 2018, Becton, Dickinson, and Company (BD) Alaris Plus medical syringe pumps (models Alaris GS, Alaris GH, Alaris CC, and Alaris TIVA) versions 2.3.6 and prior had an improper authentication vulnerability that may allow a remote attacker to gain unauthorized access to the pump according to CVE 2018-14786 with a CVSS base score of 9.4. Another vulnerability for the BD Alaris Plus medical syringe pumps is disclosed by CVE 2020-25165.

### C. First Moment Results

Note that, due to symmetry, this conditional expectation depends on i and k but not on the specific choice of the source in group k. Because there are seven groups, the number of terms to be computed is 7²=49. Due again to symmetry, whenever i≠k and at least one of the two groups is not 5, 6 or 7, the expected number of infected vertices in group i given that the attack starts from a vertex in group k is just equal to the expected number of vertices in group i times the common probability that the directed path going from the source to a fixed vertex in group k is open. The other cases are more complicated due to possible overlaps.

### Example— We have

E₇ (S₇)=1+(μ−1)q₇p₇+(μ₅−1)μ q₇q₅p₅p₇

Proof Let x, y ∈ V₇, and let V′₇ be the vertices in group 7 connected to the same vertex in group 5 as vertex x.

TABLE 4
The first moment given the origin x starts in one of the seven medical components.

| Eₓ(Sᵢ) | i = 1 | i = 2 | i = 3 | i = 4 | i = 5 | i = 6 | i = 7 |
|---|---|---|---|---|---|---|---|
| x ϵ V₁ | 1 + q₁(μ₁ − 1)p₁ | q₁μ₂p₂ | q₁ | q₁q₃ | q₁q₃μ₅p₅ | q₁q₃μ₅p₅μp₆ | q₁q₃μ₅p₅μp₇ |
| x ϵ V₂ | q₂μ₁p₁ | 1 + q₂(μ₂ − 1)p₂ | q₂ | q₂q₃ | q₂q₃μ₅p₅ | q₂q₃μ₅p₅μp₆ | q₂q₃μ₅p₅μp₇ |
| x ϵ V₃ | μ₁p₁ | μ₂p₂ | 1 | q₃ | q₃μ₅p₅ | q₃μ₅p₅μp₆ | q₃μ₅p₅μp₇ |
| x ϵ V₄ | p₃μ₁p₁ | p₃μ₂p₂ | ρ₃ | 1 | μ₅p₅ | μ₅p₅μp₆ | μ₅p₅μp₇ |
| x ϵ V₅ | q₅p₃μ₁p₁ | q₅p₃μ₂p₂ | q₅p₃ | q₅ | 1 + q₅(μ₅ − | (1 + q₅(μ₅ − 1)p₅) μp₆ | (1 + q₅(μ₅ − 1)p₅) μp₇ |
| | | | | | 1)p₅ | | |
| x ϵ V₆ | q₆q₅p₃ μ₁ρ₁ | q₆q₅p₃ μ₂ρ₂ | q₆q₅p₃ | q₆q₅ | q₆(1 + q₅(μ₅ − | 1 + q₅((μ − 1) + | q₆(1 + q₅(μ₅ − |
| | | | | | 1)p₅ | q₅(μ₅ − 1)p₅μ)p₆ | 1)p₅) μp₇ |
| x ϵ V₇ | q₇q₅q₃μ₁ρ₁ | q₇q₅q₃μ₂ρ₂ | q₇q₅q₃ | q₇q₅ | q₇(1 + q₅(μ₅ − | q₇(1 + q₅(μ₅ − | 1 + q₇((μ − 1) + q₅(μ₅ − |
| | | | | | 1)p₅ | 1)p₅)μp₆ | 1)p₅μ)p₇ |

Then, for all the vertices y in group 7, the graph distance d(x,y) is either 0, 2 or 4, and the expected number of vertices in each case is

$$\begin{matrix}E ( card \{ y ∈ {V}_{7} : d ( x , y ) = 0 ) = E ( card \{ x \} ) = 1 \\ E ( card \{ y ∈ {V}_{7} : d ( x , y ) = 2 ) = E ( card ( {V}_{7}^{′} \backslash \{ x \} ) ) \\ = μ - 1 \\ E ( card \{ y ∈ {V}_{7} : d ( x , y ) = 4 ) = E ( card ( {V}_{7} \backslash {V}_{7}^{′} ) ) \\ = {μ}_{5} μ - μ \\ = ( {μ}_{5} - 1 ) μ\end{matrix} . \qquad ( 5 )$$

In addition, the probability that the unique patch connection x and y is open only depends on the graph distance d(x,y) and we get

P(x→y is open|d(x,y)=0)=1

P(x→y is open|d(x,y)=2)=q₇p₇

P(x→y is open|d(x, y)=4)=q₇q₅p₅p₇. (6)

Combining (1)-(6), we conclude that

$$\begin{matrix}{E}_{x} ( {S}_{i} ) = E ( {E}_{x} ( {S}_{i} \vert G ) ) \\ = E ( card \{ y : d ( x , y ) = 0 ) P ( x \to y is open \vert d ( x , y ) = 0 ) + \\ E ( card \{ y : d ( x , y ) = 2 ) P ( x \to y is open \vert d ( x , y ) = 2 ) + \\ E ( card \{ y : d ( x , y ) = 4 ) P ( x \to y is open \vert d ( x , y ) = 4 ) \\ = 1 + ( μ - 1 ) {q}_{7} {p}_{7} ( {μ}_{5} - 1 ) μ {q}_{7} {q}_{5} {p}_{5} {p}_{7}\end{matrix} .$$

This completes the proof.

Following the same reasoning as in the proof of C, one can derive the 49 conditional expected values reported in Table 4.

### D. Second Moment Results

In this case, there are 7³=343 terms to be computed, and, as an illustration, we compute E₇(S₇²), which is one of the most complicated terms.

### Example— The second moment of S₇ given that the infection starts from V₇ is

$${E}_{7} ( {S}_{7}^{2} ) = 1 + 3 ( μ - 1 ) {q}_{7} {p}_{7} + ( μ - 1 ) ( μ - 2 ) {q}_{7} {p}_{7}^{2} + 3 ( {μ}_{5} - 1 ) μ {q}_{7} {q}_{5} {p}_{5} {p}_{7} + 3 ( {μ}_{5} - 1 ) ( μ - 1 ) μ {q}_{7} {q}_{5} {p}_{5} {p}_{7}^{2} + ( {μ}_{5} - 1 ) ( {μ}_{5} - 2 ) {μ}^{2} {q}_{7} {q}_{5} {p}_{5}^{2} {p}_{7}^{2} .$$

Proof Let x, y, z ϵ V₇. The probability that the two paths x→y and x→z are open depends on both the number of overlaps among the three vertices and the number of vertices in group 5 these three vertices are connected to by an edge, which we denote by
X=card {x, y, z} and
Y=card {w ∈ V₅: d(w, x)=1 or d(w, y)=1 or d(w, z)=1}.

Vertices in disjoint subtrees cannot be equal, so we have X≥Y, and six possible scenarios:

When X=1 and Y=1, there is only one choice for y and z and

P(x→y and x→z are open)=P(x→x is open)=1. (7)

When X=2 and Y=1, let w be the vertex in group 5 adjacent to x. Then, there are μ−1 leaves different from x in the subtree starting at w. There are four different ways to place y and on x and the other leaf but only three ways so that X=2, which gives

card {(y, z) ∈ V₇×V₇: X=2 and Y=1}=3(μ−1). (8)

In addition, for all choices, the edge x→w and one edge starting from w must be open for y and z to be infected. Assuming without loss of generality that y≠x, this gives

P(x→y and x→z are open)=P(x→w and w→y are open)=q₇p₇. (9)

When X=3 and Y=1, there are clearly

card {(y,z) ∈ V₇×V₇:X=3 and Y=1}=(μ−1)(μ−2). (10)

possible choices for y and z, and for all choices

$$\begin{matrix}P ( x \to y and x \to z are open ) = P ( x \to w , w \to y and \\ w \to z are open ) \\ = {q}_{7} {p}_{7}^{2}\end{matrix} . \qquad ( 11 )$$

When X=2 and Y=2, let w′ be the vertex in group 5 non-adjacent to x but adjacent to y or z or both. There are μ₅−1 possible choices for w′ and μ leaves in the subtree starting from w′. As previously, there are also four different ways to place y and z on x and the other leaf but only three ways so that X=2 therefore

card {(y,z) ∈ V₇×V₇:X=2 and Y=2}=3 (μ₅−1)μ (12)

In addition, assuming for instance that y≠x, because the graph distance between x and y is now 4, regardless of the exact location of the vertices, we have

P(x→y and x→z are open)=P(x→w, w→4, 4→w′ and

w′→y are open)=q₇q₅p₅p₇. (13)

When X=3 and Y=2, there are again μ₅−1 possible choices for w′ and μ leaves in the subtree starting from w′. After choosing one leaf, there are 2(μ−1) leaves different from x left in the two subtrees, which gives μ(μ−1) unordered possible pairs. Finally, there are four different ways to place y and z on these two leaves but only three ways so that at least one vertex is in the subtree starting at w′ to make Y=2, so a total of

card {(y,z) ∈ V₇×V₇:X=3 and Y=2}=3 (μ₅−1)(μ−1)μ (14)

possible choices for y and z. In addition, for all possible choices, the probability that both y and z are infected is always the same. Assuming that y and z are both in the subtree starting at w′ to fix the ideas, we have

$$\begin{matrix}P ( x \to y and x \to z are open ) = P ( x \to w , w \to 4 , 4 \to {w}^{′} , \\ {w}^{′} \to y and {w}^{′} \to z are open ) \\ = {q}_{7} {q}_{5} {p}_{5} {p}_{7}^{2}\end{matrix} . \qquad ( 15 )$$

When X=3 and Y=3, let w′ be the unique vertex in group 5 adjacent to y and let w″ be the unique vertex in group 5 adjacent to z. Then, there are (μ5−1)(μ5−2) possible choices for w′ and w″ so that w, w′, w″ are all three distinct and, for each of these choices, μ leaves in each of the subtrees starting from w′ and w″, which gives a total of

card {(y, z) ∈ V₇×V₇:X=3 and Y=3}=(μ−1)(μ₅−2)μ² (16)

possible choices for y and z. In addition, for all choices,

P(x→y and x→z are open)=P(x→w, w→4, 4→w′, w′→y,

4→w″ and w″→z are open)=q₇q₅p₅²p₇². (17)

Combining (2)-(17) gives the result.

Following the same reasoning as in the proof of Example D, one can derive the 343 conditional expected values reported in Tables 5-11 below.

TABLE 5
The second moment given the origin x starts in V₁ for an IMW.

| V₂ | S₁ | S₂ | S₃ | S₄ | S₅ | S₆ | S₇ |
|---|---|---|---|---|---|---|---|
| S₁ | 1 + 3(μ₁ − 1)q₁ρ₁ + | q₁μ₁ρ₂ × | q₁(1 + (μ₁ − 1)ρ₁) | q₁q₃ × | q₁q₃μ₅ρ₅(1 + | q₁q₃μ₅ρ₅μρ₆ × | q₁q₃μ₅ρ₅μρ₇ × |
| | (μ₁ − 1)(μ₁ − | (1 + (μ₁ − 1)p₁) | | (1 + (μ₁ − 1)ρ₁) | (μ₁ − 1)ρ₁) | (1 + (μ₁ − 1)ρ₁) | (1 + (μ₁ − 1)ρ₁) |
| | 2)q₁ρ₁² | | | | | | |
| S₂ | q₁μ₂ρ₂(1 + | q₁μ₂ρ₂ × | q₁μ₂ρ₂ | q₁μ₂ρ₂q₃ | q₁μ₂ρ₂q₃μ₅ρ₅ | q₁μ₂ρ₂q₃μ₅ρ₅μρ₆ | q₁μ₂ρ₂q₃μ₅ρ₅μρ₇ |
| | (μ₁ − 1)ρ₁) | (1 + (μ₁ − 1)ρ₁) | | | | | |
| S₃ | q₁(1 + (μ₁ − | q₁μ₂ρ₂ | q₁ | q₁q₃ | q₁q₃μ₅p₅ | q₁q₃μ₅ρ₅μρ₆ | q₁q₃μ₅ρ₅μρ₇ |
| | 1)ρ₁) | | | | | | |
| S₄ | q₁q₃(1 + | q₁μ₂ρ₂q₃ | q₁q₃ | q₁q₃ | q₁q₃μ₅ρ₅ | q₁q₃μ₅ρ₅μρ₆ | q₁q₃μ₅ρ₅μρ₇ |
| | (μ₁ − 1)ρ₁) | | | | | | |
| S₅ | q₁q₃μ₅ρ₅μρ₆ × | q₁μ₂ρ₂q₃μ₅ρ₅ | q₁q₃μ₅ρ₅ | q₁q₃μ₅ρ₅ | q₁q₃μ₅ρ₅(1 + | q₁q₃μ₅ρ₅μρ₆ × | q₁q₃μ₅ρ₅μρ₇ × |
| | (1 + (μ₁ − 1)ρ₁) | | | | (μ₅ − 1)ρ₁) | (1 + (μ₅ − 1)ρ₅) | (1 + (μ₅ − 1)ρ₅) |
| S₆ | q₁q₃μ₅ρ₅μρ₁ × | q₁μ₂ρ₂q₃μ₅ρ₅μρ₆ | q₁q₃μ₅ρ₅μρ₆ | q₁q₃μ₅ρ₅μρ₆ | q₁q₃μ₅ρ₅μρ₆ × | q₁q₃μ₅ρ₅μρ₆ × | q₁q₃μ₅ρ₅μ²ρ₆ρ₇ × |
| | (1 + (μ₁ − 1)ρ₁) | | | | (1 + (μ₅ − 1)ρ₅) | (1 + (μ − 1)ρ₆ + | (1 + (μ₅ − 1)ρ₅) |
| | | | | | | (μ₅ − 1)μρ₅ρ₆) | |
| S₇ | q₁q₃μ₅ρ₅μρ₇ × | q₁μ₂ρ₂q₃μ₅ρ₅μρ₇ | q₁q₃μ₅ρ₅μρ₇ | q₁q₃μ₅μρ₇ | q₁q₃μ₅μρ₇ × | q₁q₃μ₅ρ₅μ₂ρ₆ρ₇ × | q₁q₃μ₅ρ₅μρ₇ × |
| | (1 + (μ₁ − 1)ρ₁) | | | | (1 + (μ₅ − 1)ρ₅) | (1 + (μ₅ − 1)ρ₅) | (1 + (μ − 1)ρ₇ + |
| | | | | | | | (μ₅ − 1)μρ₅p₇) |

TABLE 6
The second moment given the origin x starts in V₂ for a DW.

| V₂ | S₁ | S₂ | S₃ | S₄ | S₅ | S₆ | S₇ |
|---|---|---|---|---|---|---|---|
| S₁ | q₂μ₁ρ₁ × | q₂μ₁_{ρ}_{₁}× | q₂μ₁ρ₁ | q₂μ₁ρ₁q₃ | q₂μ₁ρ₁q₃μ₅ρ₅ | q₂μ₁ρ₁q₃μ₅p₅μρ₆ | q₂μ₁ρ₁q₃μ₅ρ₅μρ₇ |
| | (1 + (μ₁ − 1)ρ₁) | (1 + (μ₂ − 1)ρ₂) | | | | | |
| S₂ | q₂μ₁ρ₁ × | 1 + 3(μ₂ − 1)q₂ρ₂ + | q₂(1 + (μ₂ − 1)ρ₂) | q₂q₃ × | q₂q₃μ₅ρ₅ × | q₂q₃μ₅ρ₅ × | q₂q₃μ₅ρ₅μρ₇ × |
| | (1 + (μ₂ − 1)ρ₂) | (μ₂ − 1)(μ₂ − | | (1 + (μ₂ − 1)ρ₂) | (1 + (μ₂ − 1)ρ₂) | (1 + (μ₂ − 1)ρ₂) | (1 + (μ₂ − 1)ρ₂) |
| | | 2)q₂ρ₂² | | | | | |
| S₃ | q₂μ₁ρ₁ | q₂(1 + (μ₂ − 1)ρ₂) | q₂ | q₂q₃ | q₂q₃μ₅ρ₅ | q₂q₃μ₅ρ₅μρ₆ | q₂q₃μ₅ρ₅μρ₇ |
| S₄ | q₂μ₁ρ₁q₃ | q₂q₃(1 + (μ₂ − 1)ρ₂) | q₂q₃ | q₂q₃ | q₂q₃μ₅ρ₅ | q₂q₃μ₅ρ₅μρ₆ | q₂q₃μ₅ρ₅μρ₇ |
| S₅ | q₂μ₁ρ₁q₃μ₅ρ₅ | q₂q₃μ₅ρ₅(1 + | q₂q₃μ₅ρ₅ | q₂q₃μ₅ρ₅ | q₂q₃μ₅ρ₅(1 + | q₂q₃μ₅ρ₅μρ₆ × | q₂q₃μ₅ρ₅μρ₇ × |
| | | (μ₂ − 1)ρ₂) | | | (μ₅ − 1)ρ₅) | (1 + (μ₅ − 1)ρ₅) | (1 + (μ₅ − 1)ρ₅) |
| S₆ | q₂μ₁ρ₁q₃μ₅ρ₅μρ₆ | q₂q₃μ₅ρ₅μρ₆ × | q₂q₃μ₅ρ₅μρ₆ | q₂q₃μ₅ρ₅μρ₆ | q₂q₃μ₅ρ₅μρ₆ × | q₂q₃μ₅ρ₅μρ₆ × | q₂q₃μ₅ρ₅μ²ρ₆ρ₇ × |
| | | (1 + (μ₂ − 1)ρ₂) | | | (1 + (μ₅ − 1)ρ₅) | (1 + (μ − 1)ρ₆ + | (1 + (μ₅ − 1)ρ₅) |
| | | | | | | (μ₅ − 1)μρ₅ρ₆) | |
| S₇ | q₂μ₁ρ₁q₃μ₅μρ₇ | q₂q₃μ₅ρ₅μρ₇ × | q₂q₃μ₅ρ₅μρ₇ | q₂q₃μ₅ρ₅μρ₇ | q₂q₃μ₅ρ₅μρ₇ × | q₂q₃μ₅ρ₅μ²ρ₆ρ₇ × | q₂q₃μ₅ρ₅μρ₇ × |
| | | (1 + (μ₂ − 1)ρ₂) | | | (1 + (μ₅ − 1)ρ₅) | (1 + (μ₅ − 1)ρ₅) | (1 + (μ − 1)ρ₇ + |
| | | | | | | | (μ₅ − 1)μρ₅ρ₇) |

TABLE 7
The second moment given the origin x starts in V₃ for a PACS.

| V₃ | S₁ | S₂ | S₃ | S₄ | S₅ | S₆ | S₇ |
|---|---|---|---|---|---|---|---|
| S₁ | μ₁ρ₁ × | μ₁ρ₁μ₂ρ₂ | μ₁ρ₁ | μ₁ρ₁q₃ | μ₁ρ₁q₃μ₅ρ₅ | μ₁ρ₁q₃μ₅ρ₅μρ₆ | μ₁ρ₁q₃μ₅ρ₅μρ₇ |
| | (1 + (μ₁ − 1)ρ₁) | | | | | | |
| S₂ | μ₁ρ₁μ₂ρ₂ | μ₂ρ₂ × | μ₂ρ₂ | μ₂ρ₂q₃ | μ₂ρ₂q₃μ₅ρ₅ | μ₂ρ₂q₃μ₅ρ₅μρ₆ | μ₂ρ₂q₃μ₅ρ₅μρ₇ |
| | | (1 + (μ₂ − 1)ρ₂) | | | | | |
| S₃ | μ₁ρ₁ | μ₂ρ₂ | 1 | q₃ | q₃μ₅ρ₅ | q₃μ₅ρ₅μρ₆ | q₃μ₅ρ₅μρ₇ |
| S₄ | μ₁ρ₁q₃ | μ₂ρ₂q₃ | q₃ | q₃ | q₃μ₅ρ₅ | q₃μ₅ρ₅μρ₆ | q₃μ₅ρ₅μρ₇ |
| S₅ | μ₁ρ₁q₃μ₅ρ₅ | μ₂ρ₂q₃μ₅ρ₅ | q₃μ₅ρ₅ | q₃μ₅ρ₅ | q₃μ₅ρ₅(1 + | q₃μ₅ρ₅μρ₆(1 + | q₃μ₅ρ₅μρ₇(1 + |
| | | | | | (μ₅ − 1)ρ₅) | (μ₅ − 1)ρ₅) | (μ₅ − 1)ρ₅) |
| S₆ | μ₁ρ₁q₃μ₅ρ₅μρ₆ | μ₂ρ₂q₃μ₅ρ₅μρ₅ | q₃μ₅ρ₅μρ₆ | q₃μ₅ρ₅μρ₆ | q₃μ₅ρ₅μρ₇ × | q₃μ₅ρ₅μρ₆(1 + | q₃μ₅ρ₅μ²ρ₆ρ₇ × |
| | | | | | (1 + (μ₅ − 1)ρ₅) | (μ − 1)ρ₆ + (μ₅ − | (1 + (μ₅ − 1)ρ₅) |
| | | | | | | 1)μρ₅ρ₆) | |
| S₇ | μ₁ρ₁q₃μ₅ρ₅μρ₇ | μ₂ρ₂q₃μ₅ρ₅μρ₇ | q₃μ₅ρ₅μρ₇ | q₃μ₅ρ₅μρ₇ | q₃μ₅ρ₅μρ₇ × | q₃μ₅ρ₅μ²ρ₆ρ₇ × | q₃μ₅ρ₅μρ₇(1 + |
| | | | | | (1 + (μ₅ − 1)ρ₅) | (1 + (μ₅ − 1)ρ₅) | (μ − 1)ρ₇ + (μ₅ − 1)μρ₅ρ₇) |

TABLE 8
The second moment given the origin x starts in V₄ for a HIS.

| V₄ | S₁ | S₂ | S₃ | S₄ | S₅ | S₆ | S₇ |
|---|---|---|---|---|---|---|---|
| S₁ | p₃μ₁p₁ × | p₃μ₁p₁μ₂p₂ | p₃μ₁p₁ | p₃μ₁p₁ | p₃μ₁p₁μ₅p₅ | p₃μ₁p₁μ₅p₅μ₆ | p₃μ₁p₁μ₅p₅μ₇ |
| | (1 + (μ₁ − 1)p₁) | | | | | | |
| S₂ | p₃μ₁p₁μ₂p₂ | p₃μ₂p₂ × | p₃μ₂p₂ | p₃μ₂p₂ | p₃μ₂p₂μ₅p₅ | p₃μ₂p₂μ₅p₅μ₆ | p₃μ₂p₂μ₅p₅μ₇ |
| | | (1 + (μ₁ − 1)P₁) | | | | | |
| S₃ | p₃μ₁p₁ | p₃μ₂p₂ | p₃ | p₃ | p₃μ₅p₅ | P₃μ₅p₅μp₆ | p₃μ₅p₅μp₇ |
| S₄ | p₃μ₁p₁ | P₃μ₂P₂ | p₃ | 1 | μ₅p₅ | μ₅p₅μp₆ | μ₅p₅μp₇ |
| S₅ | p₃μ₁p₁μ₅p₅ | p₃μ₂p₂μ₅p₅ | p₃μ₅p₅ | μ₅p₅ | μ₅p₅(1 + | μ₅p₅μp₆(1 + | μ₅p₅μp₇(1 + |
| | | | | | (μ₅ − 1)p₅) | (μ₅ − 1)p₅) | (μ₅ − 1)p₅) |
| S₆ | p₃μ₁p₁μ₅p₅μ₆ | p₃μ₂p₂μ₅p₅μ₆ | p₃μ₅p₅μ₆ | μ₅p₅μ₆ | μ₅p₅μp₆(1 + | μ₅p₅μp₆(1 + | μ₅p₅μ²p₆p₇(1 + |
| | | | | | (μ₅ − 1)p₅) | (μ − 1)p₆ + | (μ₅)p₅) |
| | | | | | | (μ₅ − 1)μp₅p₆) | |
| S₇ | p₃μ₁p₁μ₅p₅μ₇ | p₃μ₂p₂μ₅p₅μ₇ | p₃μ₅p₅μ₇ | μ₅p₅μ₇ | μ₅p₆μp₇(1 + | μ₅p₅μ²p₆p₇(1 + | μ₅p₅μp₇(1 + |
| | | | | | (μ₅ − 1)p₅) | (μ₅ − 1)p₅) | (μ − 1)p₇ + |
| | | | | | | | (μ₅ − 1)μp₅p₇) |

TABLE 9
The second moment given the origin x starts in V₅ for a CNS.

| V₅ | S₁ | S₂ | S₃ | S₄ | S₅ | S₆ | S₇ |
|---|---|---|---|---|---|---|---|
| S₁ | q₅p₃μ₁p₁ × | q₅p₃μ₁p₁μ₂p₂ | q₅p₃μ₁p₁ | q₅p₃μ₁p₁ | q₅p₃μ₁p₁(1 + | q₅p₃μ₁p₁μp₆(1 + | q₅p₃μ₁p₁μp₇(1 + |
| | 1 + (μ₁ − 1)P₁ | | | | (μ₅ − 1)p₅) | (μ₅ − 1)p₅) | (μ₅ − 1)p₅) |
| S₂ | q₅p₃μ₁p₁μ₂p₂ | q₅p₃μ₂p₂ × | q₅p₃μ₂p₂ | q₅p₃μ₂p₂ | q₅p₃μ₂p₂(1 + | q₅p₃μ₂p₂μp₆(1 + | q₅p₃μ₂p₂μp₇(1 + |
| | | 1 + (μ₂ − 1)P₂ | | | (μ₅ − 1)p₅) | (μ₅ − 1)p₅) | (μ₅ − 1)p₅) |
| S₃ | q₅p₃μ₁p₁ | q₅p₃μ₂p₂ | q₅p₃ | q₅p₃ | q₅p₃(1 + (μ₅ − 1)p₅) | q₅p₃p₆(1 + | q₅p₃p₇(1 + |
| | | | | | | (μ₅ − 1)p₅) | (μ₅ − 1)p₅) |
| S₄ | q₅p₃μ₁p₁ | q₅p₃μ₂p₂ | q₅p₃ | q₅ | q₅(1 + (μ₅ − 1)p₅) | q₅μp₆(1 + | q₅μp₇(1 + |
| | | | | | | (μ₅ − 1)p₅) | (μ₅ − 1)p₅) |
| S₅ | q₅p₃μ₁p₁ × | q₅p₃μ₂p₂ × | q₅p₃ × | q₅(1 + (μ₅ − 1)p₅) | 1 + 3(μ₅ − 1)q₅p₅ + | μp₆(1 + 3(μ₅ − | μp₇(1 + 3(μ₅ − |
| | (1 + (μ₅ − 1)p₅) | (1 + (μ₅ − 1)p₅) | (1 + (μ₅ − 1)p₅) | | (μ₅ − 1)(μ₅ − | 1)q₅p₅ + | 1)q₅p₅ + |
| | | | | | 2)q₅p₅² | (μ₅ − 1)(μ₅ − | (μ₅ − 1)(μ₅ − |
| | | | | | | 2)q₅p₅² | 2)q₅p₅² |
| S₆ | q₅p₃μ₁p₁μp₆ × | q₅p₃μ₂p₂μp₆ × | q₅p₃μp₆ × | q₅μp₆ × | μp₆(1 + 3(μ₅ − | μp₆[1 + (μ − 1)p₆ + | μ²p₆p₇ × |
| | (1 + (μ₅ − 1)p₅) | (1 + (μ₅ − 1)p₅) | (1 + (μ₅ − 1)p₅) | (1 + (μ₅ − 1)p₅) | 1)q₅p₅ + | 2(μ₅ − 1)μq₅p₅p₆ + | (1 + 3(μ₅ − 1)q₅p₅ + |
| | | | | | (μ₅ − 1)(μ₅ − | (μ₅ − 1)(1 + (μ − | (μ₅ − 1)(μ₅ − |
| | | | | | 2)q₅p₅² | 1)p₆)q₅p₅ + | 2)q₅p₅² |
| | | | | | | (μ₅ − 1)(μ₅ − | |
| | | | | | | 2)μq₅p₅²p₆] | |
| S₇ | q₅p₃μ₁p₁μp₇ × | q₅p₃μ₂p₂μp₇ × | q₅p₃μp₇ × | q₅μp₇ × | μp₇(1 + 3(μ₅ − | μ²p₆p₇(1 + | μp₇[1 + (μ − 1)p₇ + |
| | (1 + (μ₅ − 1)p₅) | (1 + (μ₅ − 1)p₅) | (1 + (μ₅ − 1)p₅) | (1 + (μ₅ − 1)p₅) | 1)q₅p₅ + | 3(μ₅ − 1)q₅p₅ + | 2(μ₅ − 1)μq₅p₅p₇ + |
| | | | | | (μ₅ − 1)(μ₅ − | (μ₅ − 1)(μ₅ − | (μ₅ − 1)(1 + (μ − |
| | | | | | 2)q₅p₅² | 2)q₅p₅² | 1)p₇)q₅p₅ + |
| | | | | | | | (μ₅ − 1)(μ₅ − |
| | | | | | | | 2)μq₅p₅²p₇] |

TABLE 10
The second moment given the origin x starts in V₆ for a PM.

| V₆ | S₁ | S₂ | S₃ | S₄ | S₅ | S₆ | S₇ |
|---|---|---|---|---|---|---|---|
| S₁ | q₆q₅p₃μ₁p₁ × | q₆q₅p₃μ₁p₁μ₂p₂ | q₆q₅p₃μ₁p₁ | q₆q₅p₃μ₁p₁ | q₆q₅p₃μ₁p₁ × | q₅q₆p₃μ₁p₁(1 + | q₆q₅p₃μ₁p₁ × |
| | 1 + (μ₁ − 1)P₁ | | | | (1 + (μ₅ − 1)P₅) | (μ − 1)p₆ + | (1 + (μ₅ − 1)p₅) |
| | | | | | | (μ₅ − 1)p₅p₆) | |
| S₂ | q₆q₅p₃μ₁p₁μ₂p₂ | q₆q₅p₃μ₂p₂ × | q₆q₅p₃μ₂p₂ | q₆q₅p₃μ₂p₂ | q₆q₅p₃μ₂p₂ × | q₅q₆p₃μ₂p₂(1 + | q₆q₅p₃μ₂p₂ × |
| | | 1 + (μ₂ − 1)P₂ | | | (1 + (μ₅ − 1)p₅) | (μ − 1)p₆ + | (1 + (μ₅ − 1)p₅) |
| | | | | | | (μ₅ − 1)μp₅p₆ | |
| S₃ | q₆q₅p₃μ₁p₁ | q₆q₅p₃μ₂p₃ | q₆q₅p₃ | q₆q₅p₃ | q₆q₅p₃(1 + | q₅q₆p₃(1 + | q₆q₅p₃μp₇(1 + |
| | | | | | (μ₅ − 1)p₅) | (μ − 1)p₆ + | (μ₅ − 1)p₅) |
| | | | | | | (μ₅ − 1)μp₅p₆) | |
| S₄ | q₆q₅p₃μ₁p₁ | q₆q₅p₃μ₂p₂ | q₆q₅p₃ | q₆q₅ | q₆q₅(1 + | q₅q₆(1 + (μ − 1)p₆ + | q₆q₅μp₇(1 + |
| | | | | | (μ₅ − 1)p₅) | (μ₅ − 1)μp₅p₆) | (μ₅ − 1)p₅) |
| S₅ | q₆q₅p₃μ₁p₁ × | q₆q₅p₃μ₂p₂ × | q₆q₅p₃ × | q₆q₅ × | q₆(1 + 3(μ₅ − | q₆[1 + (μ − 1)p₆ + | μq₆p₇(1 + 3(μ₅ − |
| | (1 + (μ₅ −)p₅) | (1 + (μ₅ − 1)p₅) | (1 + (μ₅ − 1)p₅) | (1 + (μ₅ − 1)p₅) | 1)q₅p₅ + | (μ₅ − 1)q₅p₆ + | 1)q₅p₅ + |
| | | | | | (μ₅ − 1)(μ₅ − | (μ₅ − 1)(3μ − | (μ₅ − 1)(μ₅ − |
| | | | | | 2)q₅p₅² | 1)q₅p₅p₆ + | 2)q₅p₅²) |
| | | | | | | (μ₅ − 1)(μ₅ − | |
| | | | | | | 2)μq₅p₅²p₆] | |
| S₆ | q₅q₆p₃μ₁p₁ × | q₅q₆p₃μ₂p₂ × | q₅q₆p₃ × | q₅q₆(1 + | q₆[1 + (μ − 1)p₆ + | 1 + 3(μ − 1)q₆p₆ + | μq₆p₇[1 + |
| | (1 + (μ − 1)p₆ + | (1 + (μ − 1)p₆ + | (1 + (μ − 1)p₆ + | (μ − 1)p₆ + | (μ₅ − 1)q₆p₅ + | (μ − 1)(μ − 2)q₆p₆² + | (μ − 1)p₆ + |
| | (μ₅ − 1)μp₅p₆) | (μ₅ − 1)μp₅p₆) | (μ₅ − 1)μp₅p₆) | (μ₅ − 1)μp₅p₆ | (μ₅ −1)(3μ − | 3(μ₅ − 1)μq₆q₅p₅p₆ + | (μ₅ − 1)q₅p₅ + |
| | | | | | 1)q₅p₅p₆ + | 3(μ₅ − 1)(μ − | (μ₅ − 1)(3μ − |
| | | | | | (μ₅ − 1)(μ₅ − | 1)μq₆q₅p₅p₆² + | 1)q₅p₅p₆ + |
| | | | | | 2)μq₅p₅²p₆] | (μ₅ − 1)(μ₅ − | (μ₅ − 1)(μ₅ − |
| | | | | | | 2)μ²q₆q₅p₅²p₆² | 2)μq₅p₅²p₆] |
| S₇ | q₆q₅p₃μ₁p₁μp₇ × | q₆q₅p₃μ₂p₂μp₇ × | q₆q₅p₃μp₇ × | q₆q₅μp₇ × | μq₆p₇(1 + | μq₆p₇[1 + | μq₆p₇[1 + (μ − 1)p₇ |
| | (1 + (μ₅ − 1)p₅) | (1 + (μ₅ − 1)p₅) | (1 + (μ₅ − 1)p₅) | (1 + (μ₅ − 1)p₅) | 3(μ₅ − 1)q₅p₅ + | (μ − 1)p₆ + | (μ₅ − 1)q₅p₅ + |
| | | | | | (μ₅ − 1)(μ₅ − | (μ₅ − 1)q₅p₅ + | (μ₅ − 1)(3μ − |
| | | | | | 2)q₅p₅²) | (μ₅ − 1)(3μ − | 1)q₅p₅p₇ + |
| | | | | | | 1)q₅p₅p₆ + | (μ₅ − 1)(μ₅ − |
| | | | | | | (μ₅ − 1)(μ₅ − | 2)μq₅p₅²p₇] |
| | | | | | | 2)μq₅p₅²p₆] | |

TABLE 11
The second moment given the origin x starts in V₇ for an IP.

| V₂ | S₁ | S₂ | S₃ | S₄ | S₅ | S₆ | S₇ |
|---|---|---|---|---|---|---|---|
| S₁ | q₇q₅p₃μ₁p₁ × | q₇q₅p₃μ₁p₁μ₂p₂ | q₇q₅p₃μ₁p₁ | q₇q₅p₃μ₁p₁ | q₇q₅p₃μ₁p₁ × | q₇q₅p₃μ₁p₁μp₆ × | q₅q₇p₃μ₁p₁(1 + |
| | 1 + (μ₁ − 1)P₁ | | | | (1 + (μ₅ − 1)P₅) | (1 + (μ₅ − 1)p₅) | (μ − 1)p₇ + |
| | | | | | | | (μ₅ − 1)μp₅p₇) |
| S₂ | q₇q₅p₃μ₁p₁μ₂p₂ | q₇q₅p₃μ₂p₂ × | q₇q₅p₃μ₂p₂ | q₇q₅p₃μ₂p₂ | q₇q₅p₃μ₂p₂ × | q₇q₅p₃μ₂p₂ × | q₅q₇p₃μ₂p₂(1 + |
| | | 1 + (μ₂ − 1)P₂ | | | (1 + (μ₅ − 1)p₅) | (1 + (μ₅ − 1)p₅) | (μ − 1)p₇ + |
| | | | | | | | (μ₅ − 1)μp₅p₇) |
| S₃ | q₇q₅p₃μ₁p₁ | q₇q₅p₃μ₂p₂ | q₇q₅p₃μ₂p₂ | q₇q₅p₃ | q₇q₅p₃(1 + | q₇q₅p₃μp₆(1 + | q₅q₇p₃(1 + |
| | | | | | (μ₅ − 1)p₅) | (μ₅ − 1)p₅) | (μ − 1)p₇ + |
| | | | | | | | (μ₅ − 1)μp₅p₇) |
| S₄ | q₇q₅p₃μ₁p₁ | q₇q₅p₃μ₂p₂ | q₇q₅p₃ | q₇q₅ | q₇q₅(1 + | q₇q₅μp₆(1 + | q₅q₇(1 + (μ − 1)p₇ + |
| | | | | | (μ₅ − 1)p₅) | (μ₅ − 1)p₅) | (μ₅ − 1)μp₅p₇) |
| S₅ | q₇q₅p₃μ₁p₁ × | q₇q₅p₃μ₂p₂ × | q₇q₅p₃ × | q₇q₅ × | q₇(1 + 3(μ₅ − | μq₇p₆(1 + | q₇[1 + (μ − 1)p₇ + |
| | (1 + (μ₅ − 1)p₅) | (1 + (μ₅ − 1)p₅) | (1 + (μ₅ − 1)p₅) | (1 + (μ₅ − 1)p₅) | 1)q₅p₅ + | 3(μ₅ − 1)q₅p₅ + | (μ₅ − 1)q₅p₅ + |
| | | | | | (μ₅ − 1)(μ₅ − | (μ₅ − 1)(μ₅ − | (μ₅ − 1)(3μ − |
| | | | | | 2)q₅p₅² | 2)q₅p₅²) | 1)q₅p₅p₇ + |
| | | | | | | | (μ₅ − 1)(μ₅ − |
| | | | | | | | 2)μq₅p₅²p₇] |
| S₆ | q₇q₅p₃μ₁p_{1μp}_{₆} × | q₇q₅p₃μ₂p₂μp₆ × | q₇q₅p₃μp₆ × | q₇q₅μp₆ × | μq₇p₆(1 + 3(μ₅ − | μq₇p₆[1 + (μ − 1)p₆ + | μq₇p₆[1 + |
| | (1 + (μ₅ − 1)p₅ | (1 + (μ₅ − 1)p₅) | (1 + (μ₅ − 1)p₅) | (1 + (μ₅ − 1)p₅) | 1)q₅p₅ + | (μ₅ − 1)q₅p₅ + | (μ − 1)p₇ + |
| | | | | | (μ₅ − 1)(μ₅ − | (μ₅ − 1)(3μ − | (μ₅ − 1)q₅p₅ + |
| | | | | | 2)q₅p₅²) | 1)q₅p₅p₆ + | (μ₅ − 1)(3μ − |
| | | | | | | (μ₅ − 1)(μ₅ − | 1)q₅p₅p₇ + |
| | | | | | | 2)μq₅p₅²p₆] | (μ₅ − 1)(μ₅ − |
| | | | | | | | 2)μq₅q₅p₅²p₇] |
| S₇ | q₅q₇p₃μ₁p₁ × | q₅q₇p₃μ₂p₂ × | q₅q₇p₃ × | q₅q₇(1 + | q₇[1 + (μ − 1)p₇ + | μq₇p₆[1 + | 1 + 3(μ − 1)q₇p₇ + |
| | (1 + (μ − 1)p₇ + | (1 + (μ − 1)p₇ + | (1 + (μ − 1)p₇ + | (μ − 1)p₇ + | (μ₅ − 1)q₅p₅ + | (μ − 1)p₇ + | (μ − 1)(μ − 2)q₇p₇² + |
| | (μ₅ − 1)μp₅p₇) | (μ₅ − 1)μp₅p₇) | (μ₅ − 1)μp₅p₇) | (μ₅ − 1)μp₅p₇) | (μ₅ − 1)(3μ − | (μ₅ − 1)q₅p₅ + | 3(μ₅ − |
| | | | | | 1)q₅p₅p₇ + | (μ₅ − 1)(3μ − | 1)μq₇q₅p₅p₇ + |
| | | | | | (μ₅ − 1)(μ₅ − | 1)q₅p₅p₇ + | 3(μ₅ − 1)(μ − |
| | | | | | 2)μq₅p₅²p₇] | (μ₅ − 1)(μ₅ − | 1)μq₇q₅p₅p₇² + |
| | | | | | | 2)μq₅p₅²p₇] | (μ₅ − 1)(μ₅ − |
| | | | | | | | 2)μ²q₇q₅p₅²p₇² |

### E. Legal Liability for Patient Protection

Since cyberattacks affect patient records, much legislation has been enacted to enforce healthcare responsibility. In the U.S., the Health Insurance Portability and Accountability Act (HIPAA) was passed in 1996 to enforce the protection of health information usage, disclosure, storage, and transmission (Office of the Assistant Secretary for Planning and Evaluation, 1996). In 2005, the U.S. Food and Drug Administration (FDA) published Guidance for Industry Cybersecurity for Networked Medical Devices Containing Off-the-Shelf Software that identified the manufacturer as the responsible party for the continued safety and performance of a medical device. In 2009, HIPAA was followed by the Health Information Technology for Economic and Clinical Health (HITECH) Act, to increase penalties for HIPAA violations, strengthen breach notification, and encourage the meaningful use of electronic PHI records (Mountain View: Symantec Corporation, 2010; Argaw et al., 2020). In 2016, the FDA published the Postmarket Management of Cybersecurity in Medical Devices stating the recommendation that “cyber risk management is a shared responsibility among stakeholders medical device manufacturer, the user, the IT system integrator, Health IT developers, and an array of IT vendors that provide products that are not regulated by the FDA” (U.S. Food and Drug Administration (FDA), 2016). In the same year, the European Union adopted the Network and Information System Directive, which was the first E.U. law specifically for cybersecurity, that required member states to adopt national cybersecurity strategies and to develop incident response teams; the directive was not fully implemented by member states until 2018 (Official Journal of the European Union, 2016a; Argaw et al., 2020). During this time, the General Data Protection Regulation (GDPR) was adopted by the E.U. to replace existing regulations, that went into effect in 2018. GDPR implemented provisions and requirements about personally identifiable information of all E.U. citizens, including provisions for breach notification and penalty implementation (Official Journal of the European Union, 2016b).

In 2017, the FDA mandated manufacturers to implement ongoing lifecycle processes and to monitor continued safety post-market (U.S. Food and Drug Administration (FDA), 2017). This included medical device manufacturers demonstrating that their devices were able to have updates and any security patches applied throughout their lifespan (U.S. Food and Drug Administration (FDA), 2018; Healthcare Information and Management Systems Society, 2017). In 2018, the Cybersecurity and Infrastructure Security Agency (CISA) was established as part of the Department of Homeland Security to defend against cyber threats and build a more secure infrastructure (Cybersecurity and Infrastructure Security Agency (CISA), 2022). In April 2021, the Cyber Response and Recovery Act was proposed to “provide additional resources and better coordination for serious cyberattacks or breaches that risk the safety and security of Americans” (U.S. Department of Homeland Security and Governmental Affairs, 2021). In 2017, the FDA mandated manufacturers to implement ongoing lifecycle processes and to monitor continued safety post-market (U.S. Food and Drug Administration (FDA), 2017). This included medical device manufacturers demonstrating that their devices were able to have updates and any security patches applied throughout their lifespan (U.S. Food and Drug Administration (FDA), 2018; Healthcare Information and Management Systems Society, 2017). In 2018, the Cybersecurity and Infrastructure Security Agency (CISA) was established as part of the Department of Homeland Security to defend against cyber threats and build a more secure infrastructure (Cybersecurity and Infrastructure Security Agency (CISA), 2022). In April 2021, the Cyber Response and Recovery Act was proposed to “provide additional resources and better coordination for serious cyberattacks or breaches that risk the safety and security of Americans” (U.S. Department of Homeland Security and Governmental Affairs, 2021).

### F. Cost Distributions

For completeness, the purpose of this appendix is to allow the reader to fully understand the cost methodology. The data used was for the United States, so the results may be different for data from countries with a national healthcare system since the purchase of medical devices in the United States healthcare system is typically conducted via confidential negotiations between private hospital managers and private suppliers (Bucciol et al., 2020). The medical purchasing prices may be more publicly available in the European Union and the United Kingdom such as those for the IMWs provided (National Audit Office, 2011; Northern Devon Healthcare, 2016).

HIS. For the replacement cost, only ranges of these costs could be found due to the aforementioned reasoning of the purchasing costs. Even though a HIS system is essentially a large data center, the software is propriety and customized for each hospital; therefore, using the cost of the replacement of a generic data center may not include the cost of the software. The replacement cost is assumed to be log normally distributed. For the loss of revenue due to downtime, which can be described as the denial of access to patient records or other hospital information, the data was converted from minutes to hours for consistency. The data was fit to a log-normal distribution. For the cost of records, the discharge distribution, which included inpatient and outpatient discharges, was multiplied by the cost of a data breach per PHI record. For the cost of a data breach per PHI record, the latest average cost of $429 was used with the variance being calculated from the time-series data for the past decade. For the diminished productivity cost, we converted the 2016 dollars to 2020 dollars for consistency. Furthermore, we converted the annual cost to hourly cost by dividing by the total number of working hours in a year, which is 2,080 hours. We assume the original data followed a log-normal distribution.

PACS. For the replacement cost, only ranges of these costs could be found due to the aforementioned reasoning of the purchasing costs. The replacement cost is assumed to be log-normally distributed. For the loss of revenue due to downtime, which can be a denial of access to patient radiology images and results, the utilized staffed beds' distribution was multiplied by the per-bed imaging revenue per hour. For the cost of records, the discharge distribution, including inpatient and outpatient discharges, was multiplied by the cost of a data breach per PHI record. Since not every patient may receive a scan, the resulting distribution was scaled by the number of MRI and CT exams for every 1,000 inhabitants. The data was fit to a log-normal distribution. For the diminished productivity cost, we use the estimated total work relative value unit (wRVU) loss for the radiological impact across three major hospital systems; particularly, we used the conservative 39% and multiply by the hourly revenue. This is to follow the concept of wRVU for a physician's service as the amount of time spent by the physician multiplied by a compensation rate (see Childers and Maggard-Gibbons (2020)). We assume the productivity cost follows a log-normal distribution.

DW. For the replacement cost, only ranges of these costs could be found due to the aforementioned reasoning of the purchasing costs. The replacement cost is assumed to be log-normally distributed. For the loss of revenue due to downtime, the distribution of the radiologist's variation of time to read procedures, which was converted to hours, and the distribution of costs of imaging procedures were multiplied to yield a final cost distribution. Since radiologists cannot read the exams if the DWs are inoperable, then the results of the exams cannot be provided, which may result in a backlog of cases that the hospital cannot yet charge for the services; therefore, these datasets must be included. The distributions were fitted log-normally. For the cost of records, it was difficult to ascertain precisely the number of cases that were downloaded onto the DWs at any given time. However, since the radiologist reads at least one case at a time, it is assumed that at least one PHI record can be compromised, so the distribution of the cost of a data breach for a single PHI record was used. For the diminished productivity cost, we use the estimated total work relative value unit (wRVU) loss for the radiological impact across three major hospital systems; particularly, we used the conservative 39% and multiply by the hourly revenue. This is to follow the concept of wRVU for a physician's service as the amount of time spent by the physician multiplied by a compensation rate (see Childers and Maggard-Gibbons (2020)). We assume the productivity cost follows a log-normal distribution.

IMW. For the replacement cost, the data was gathered from a variety of sources and was fit to a log-normal distribution. For the loss of revenue due to downtime, the distribution of imaging costs for various radiology procedures was fit to a log-normal distribution. For the cost of records, each imaging scanner can scan only one person at a time, so the distribution of the cost of a data breach for a single PHI record was used. For the diminished productivity cost, we use the estimated total work relative value unit (wRVU) loss for the radiological impact across three major hospital systems; particularly, we used the conservative 39% and multiply by the hourly revenue. This is to follow the concept of wRVU for a physician's service as the amount of time spent by the physician multiplied by a compensation rate (see Childers and Maggard-Gibbons (2020)). We assume the productivity cost follows a log-normal distribution.

CNS. For the replacement cost, a range of prices for a CNS was considered and assumed to be log-normally distributed. For the loss of revenue due to downtime in 2018 since a compromised CNS is inoperable to monitor the patients resulting in the hospital not charging this service completely during this time, the mean cost per hospital stay was divided by the mean length of stay and converted to hours for consistency. Using the time-series data, the variance of the cost per hospital stay was calculated and also converted to hours. The resulting distribution was assumed to be log-normal. For the cost of records, the cost of a data breach per PHI record was multiplied by the distribution of patient beds per CNS in the model since the health information monitored on the CNS had been compromised. For the diminished productivity cost, we converted the 2016 dollars to 2020 dollars for consistency. Furthermore, we converted the annual cost to hourly cost by dividing by the total number of working hours in a year, which is 2,080 hours. We assume the original data followed a log-normal distribution.

PM. For the replacement cost, the data consisted of a variety of sources that included different models and manufacturers that were fitted to a log-normal distribution. For the loss of revenue due to downtime in 2018 since a compromised PM is inoperable to monitor the patient resulting in the hospital not charging this service completely during this time, the mean cost per hospital stay was divided by the mean length of stay and converted to hours for consistency. Using the time-series data, the variance of the cost per hospital stay was calculated and also converted to hours. The resulting distribution was assumed to be log-normal. For the cost of records, each PM can only monitor one patient at a time, so the distribution of the cost of a data breach for a single PHI record was used. For the diminished productivity cost, we converted the 2016 dollars to 2020 dollars for consistency. Furthermore, we converted the annual cost to hourly cost by dividing by the total number of working hours in a year, which is 2,080 hours. We assume the original data followed a log-normal distribution.

IP. For the replacement cost, a range of prices for an IP was considered and assumed to be log-normally distributed. For the loss of revenue due to downtime in 2018 since a compromised IP is inoperable to administer the medication to the patient resulting in the hospital not charging this service completely during this time, the mean cost per hospital stay was divided by the mean length of stay and converted to hours for consistency. Using the time-series data, the variance of the cost per hospital stay was calculated and also converted to hours. The resulting distribution was assumed to be log-normal. For the cost of records, each IP can only be used on one patient at a time, so the distribution of the cost of a data breach for a single PHI record was used. For the diminished productivity cost, we converted the 2016 dollars to 2020 dollars for consistency. Furthermore, we converted the annual cost to hourly cost by dividing by the total number of working hours in a year, which is 2,080 hours. We assume the original data followed a log-normal distribution.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for computing aggregate loss distribution to model loss associated with cyber-attacks related to healthcare environments and infrastructure, comprising:
a processor in communication with memory, the memory including instructions executable by the processor to:
calculate an aggregate loss distribution associated with at least one cyberattack related to a network, wherein the processor:
generates a plurality of cyberattacks utilizing a random process that models times at which the plurality of cyberattacks occur,
creates a plurality of graphs, each graph in the plurality of graphs created for each cyberattack event in the plurality of cyberattack events, each graph comprising a plurality of nodes associated with devices of the network, the plurality of nodes including fixed nodes and random nodes connected by a plurality of edges, each edge in the plurality of edges including a direction and a probability of being open and each node in the plurality of nodes including a cost,
selects, for each graph in the plurality of graphs, one or more initial infected nodes in the fixed nodes and the random node of the plurality of nodes for each cyberattack of the plurality of cyberattacks,
models a spread of an infection from the one or more initial infected nodes given the direction and the probability of being open for each edge in the graph, and
calculates an expected loss and a variation of loss for the plurality of cyberattacks given the plurality of graphs, the initial infected nodes for each graph, and the expected cost of infected nodes after the spread of the infection.

2. The system of claim 1, wherein the random process is a Poisson process.

3. The system of claim 1, wherein the network is for a hospital system including medical and non-medical devices.

4. The system of claim 1, wherein the plurality of nodes in each graph is partitioned into a plurality of device groups, each device group comprising:
one or more nodes of the same device type,
a probability for being a source of the cyberattack, wherein one or more nodes in the device group is selected, by the processor, as the one or more of the initial infected nodes.
a random cost, wherein the one or more nodes in the device group is associated with the random cost.

5. The system of claim 4, further comprising:
a plurality of device group pairs, each device group pair in the plurality of device group pairs including:
a first device group in the plurality of device groups,
a second device group in the plurality of device groups,
a plurality of edges directed from the one or more nodes in the first device group to the one or more nodes in the second device group with an associated probability of being open p, and
a plurality of edge directed from the one or more nodes in the second device group to the one or more nodes in the first device group with an associated probability of being open q.

6. The system of claim 1, wherein the processor further models the spread of infection from the one or more initial infected nodes using bidirectional bond percolation.

7. The system of claim 1, wherein the cost associated with each node is a total cost, the total cost calculated from component costs including:
a cost associated with damage to the device,
a cost associated with loss of information,
a cost associated with loss of revenue, and
a cost associated with business interruption.

8. The system of claim 1, wherein the expected loss and a variation of loss is suitable for estimation of insurance premiums for the network.
